(19) United States
(12) Patent Application Publication
(10) Pub. No.: US 2026/0368846 A1
(43) Pub. Date: Nov. 19, 2026

(54) GRAPHICS PROCESSING

(71) Applicant: Arm Limited, Cambridge (GB)

(72) Inventors: Jakob Axel FRIES, Lund (SE); Jian WANG, Skåne (SE)

(73) Assignee: Arm Limited, Cambridge (GB)

(21) Appl. No.: 19/210,310

(22) Filed: May 16, 2025

(51) Int. Cl. G06T 1/20

(52) U.S. Cl. CPC G06T 1/20

(57) ABSTRACT

A tile-based graphics processor includes an accumulation buffer operable to accumulate render output data generated by a rendering circuit and provide render output data to an encoder. The processor can operate in a first mode of operation and a second mode of operation. In the first mode, the accumulation buffer provides render output data for a compression unit to the encoder for encoding in response to an indication that all render output data for the compression unit that the rendering circuit will generate for a render output has been accumulated by the accumulation buffer. In the second mode, the accumulation buffer provides render output data for a compression unit to the encoder for encoding in response to an indication that all render output data for the compression unit that the rendering circuit will generate for a single rendering tile of a render output has been accumulated by the accumulation buffer.

### BACKGROUND

The technology described herein relates to computer graphics processing, and in particular to tile-based graphics processing.

Graphics processing operations, which may be performed by a graphics processor (graphics processing unit (GPU)), typically process data in an uncompressed form. When such operations have produced a particular output (such as a tile for render output in a tile-based graphics processing system), the output data may then be written out to a (e.g. frame) buffer, for example in main memory, for storage for further processing (e.g. display of the frame).

In tile-based graphics processing, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly sized and shaped rendering tiles (they are usually e.g. squares or rectangles). The tiles are each rendered separately (e.g. one after another). The rendered tiles are then combined to provide the complete render output (e.g. frame for display).

To support such operation, a tile-based graphics processor will typically include a set of one or more tile buffers for storing tile data locally to the graphics processor while a tile is being rendered (generated). Then, once a given rendering tile has been completed for a render output, the rendering tile will be written out from the tile buffer to other storage, such as, for example, a (e.g. frame) buffer, for example in main memory.

Once all the tiles for a given render output have been written out to the (e.g. frame) buffer, then the render output can be used for further processing (e.g. provided to a display for display, or otherwise processed).

To reduce the amount of data that needs to be transferred to and stored in memory when performing tile-based graphics processing, the tile data may be stored in a compressed form in the memory.

The Applicants believe there remains scope for improvements to tile-based graphics processing.

### BRIEF DESCRIPTION OF THE DRAWINGS

Embodiments of the technology described herein will now be described by way of example only and with reference to the accompanying drawings, in which:

FIG. 1 shows an exemplary graphics processing system in which the technology described herein may be implemented;

FIG. 2 shows an exemplary graphics processing pipeline;

FIGS. 3 and 4 show schematically a graphics processor that may be operated in accordance with the technology described herein;

FIG. 5 shows an encoder of the graphics processor of FIGS. 3 and 4 in more detail;

FIG. 6 shows an exemplary compression unit layout for an output data array to be compressed;

FIG. 7 shows the corresponding rendering tile layout for the output data array of FIG. 6;

FIG. 8 illustrates the potential mismatch between a rendering tile and compression units to be encoded;

FIG. 9 shows the writing of a tile to the accumulation buffer in a first mode of operation;

FIG. 10 shows the operation of the accumulation buffer when receiving tile data in the first mode of operation;

FIG. 11 shows the operation when a compression unit is evicted from the accumulation buffer in embodiments;

FIG. 12 shows the operation when the accumulation buffer needs more data for a compression unit to be written out in embodiments;

FIGS. 13A and 13B illustrate exemplary tile-based rendering configurations;

FIGS. 14A and 14B illustrate exemplary tile-based rendering configurations;

FIG. 15 illustrates a tile-based rendering configuration;

FIG. 16 illustrates a process for selecting a tile-based rendering configuration;

FIG. 17 illustrates an exemplary tile-based rendering configuration in accordance with embodiments;

FIG. 18 shows the writing of a tile to the accumulation buffer in a second mode of operation;

FIG. 19 shows the operation of the accumulation buffer when receiving tile data in the second mode of operation; and

FIG. 20 shows a process for generating a render output in accordance with embodiments.

### DETAILED DESCRIPTION

A first embodiment of the technology described herein comprises a method of operating a graphics processing system that includes a tile-based graphics processor that is operable to generate a render output; wherein the graphics processor comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding; and
wherein the graphics processor is operable in a first mode of operation in which the accumulation buffer will provide render output data for a compression unit to the encoder for encoding in response to an indication that all render output data for the compression unit that the rendering circuit will generate for a render output has been accumulated by the accumulation buffer;
the method comprising:
causing the graphics processor to operate in a second (different) mode of operation in which the accumulation buffer will provide render output data for a compression unit to the encoder for encoding in response to an indication that all render output data for the compression unit that the rendering circuit will generate for a single rendering tile of a render output has been accumulated by the accumulation buffer.

A second embodiment of the technology described herein comprises a graphics processing system that includes a tile-based graphics processor that is operable to generate a render output; wherein the graphics processor comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding; and
wherein the graphics processor is operable in a first mode of operation in which the accumulation buffer will provide render output data for a compression unit to the encoder for encoding in response to an indication that all render output data for the compression unit that the rendering circuit will generate for a render output has been accumulated by the accumulation buffer; and
wherein the graphics processor is operable in a second (different) mode of operation in which the accumulation buffer will provide render output data for a compression unit to the encoder for encoding in response to an indication that all render output data for the compression unit that the rendering circuit will generate for a single rendering tile of a render output has been accumulated by the accumulation buffer.

The technology described herein extends to a tile-based graphics processor per se.

Thus, another embodiment of the technology described herein comprises a method of operating a tile-based graphics processor that is operable to generate a render output; wherein the tile-based graphics processor comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
wherein the graphics processor is operable in a first mode of operation in which the accumulation buffer will provide render output data for a compression unit to the encoder for encoding in response to an indication that all render output data for the compression unit that the rendering circuit will generate for a render output has been accumulated by the accumulation buffer;
the method comprising:
causing the graphics processor to operate in a second (different) mode of operation in which the accumulation buffer will provide render output data for a compression unit to the encoder for encoding in response to an indication that all render output data for the compression unit that the rendering circuit will generate for a single rendering tile of a render output has been accumulated by the accumulation buffer.

Another embodiment of the technology described herein comprises a tile-based graphics processor operable to generate a render output; the tile-based graphics processor comprising:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
wherein the graphics processor is operable in a first mode of operation in which the accumulation buffer will provide render output data for a compression unit to the encoder for encoding in response to an indication that all render output data for the compression unit that the rendering circuit will generate for a render output has been accumulated by the accumulation buffer; and
wherein the graphics processor is operable in a second (different) mode of operation in which the accumulation buffer will provide render output data for a compression unit to the encoder for encoding in response to an indication that all render output data for the compression unit that the rendering circuit will generate for a single rendering tile of a render output has been accumulated by the accumulation buffer.

The technology described herein relates to tile-based graphics processing. Thus, in embodiments, a (the) render output, e.g. frame (image) to be displayed, is divided into plural rendering tiles that (each) have a particular size and/or shape, each rendering tile is generated separately (by a rendering circuit of the graphics processor), and the separately generated rendering tiles are combined to form the complete render output (e.g. frame (image)). To facilitate this, the tile-based graphics processor/system should, and in embodiments does, comprise one or more tile buffers for storing render output data while a rendering tile is being generated, wherein once a rendering tile has been completed, it is written out from the tile buffer, e.g. to memory.

In embodiments of the technology described herein, the render output tile data is encoded (compressed) (by an encoder of the graphics processor) before being written out to memory, and stored in memory in an encoded (compressed) form. In embodiments, block-based compression is used, which encodes compression units (blocks) of uncompressed render output data (each) having a particular size and/or shape for storing in a compressed format.

While it could be the case that the compression unit size and/or shape that is used to encode the render output corresponds exactly to the size and/or shape of rendering tiles of the render output that are generated (in which case each rendering tile may simply be compressed as a respective compression unit), the compression unit and rendering tile size and/or shape may typically not match each other. For example, in some rendering configurations, a (each) rendering tile may overlap plural different compression units, such that a (each) rendering tile will generate render output data for plural different compression units. Similarly, in some rendering configurations, a (each) compression unit may overlap plural different rendering tiles, such that respective parts of a (each) compression unit will be generated separately (as separate rendering tiles).

In embodiments of the technology described herein, to account for this, the graphics processor is provided with an accumulation buffer which is configured to (try to) accumulate parts of a compression unit that are separately generated by the rendering circuit (as separate rendering tiles), and provide the “complete” compression unit to the encoder for encoding. In embodiments, the accumulation buffer can accumulate render output data in this manner for plural different compression units at the same time.

The graphics processor may thus operate in a first, “accumulation” mode of operation in which the accumulation buffer will try to accumulate as much (e.g. separately generated) render output data for a compression unit as possible, before evicting the accumulated render output data for the compression unit to the encoder for encoding.

In particular, when operating in the first (“accumulation”) mode of operation, the accumulation buffer provides (e.g. evicts) render output data for a compression unit to the encoder for encoding in response to an indication that all of the render output data for the compression unit that the rendering circuit will generate for (all of) (a group of plural rendering tiles of) a render output has been accumulated by the accumulation buffer.

This “accumulation” mode of operation may operate substantially as described in United Kingdom Patent Application Number 2405981.8, the entire contents of which is hereby incorporated herein by reference.

While “accumulation” operation has been found to facilitate improved tile-based graphics processing, the Applicants have found that there can be some rendering configurations that can result in render output data for a relatively large number of compression units needing to be accumulated in the accumulation buffer at the same time. While it would be possible to provide the accumulation buffer with sufficient storage capacity to be able to accommodate all such possible rendering configurations, the Applicants have recognised that this can be associated with increased silicon/area costs.

In embodiments of the technology described herein, therefore, the accumulation buffer is provided with sufficient capacity to accommodate some but not all (e.g. most) rendering configurations, and an “overflow” mechanism is provided to deal with the (e.g. relatively rare) situation in which the accumulation buffer capacity is exceeded.

One possible “overflow” mechanism would be to configure the accumulation buffer to evict render output data for a compression unit to the encoder whenever render output data for a new compression unit is to be accumulated by the accumulation buffer and the accumulation buffer is full. However, and as will be discussed in more detail below, the Applicants have realised that it is possible to recognise in advance when a rendering configuration will result in the accumulation buffer becoming full (overflowing), and so trigger eviction earlier.

Accordingly, in embodiments of the technology described herein, the graphics processor can operate in a second, “overflow” mode of operation in which the accumulation buffer tries to evict render output data for a (each) compression unit to the encoder at an earlier opportunity.

In particular, when operating in the second (“overflow”) mode of operation, the accumulation buffer provides (evicts) render output data for a compression unit to the encoder for encoding in response to an indication that all of the render output data for the compression unit that the rendering circuit will generate for (only) a single rendering tile of a render output has been accumulated by the accumulation buffer.

Thus, in embodiments, when it is known that the accumulation buffer capacity will be exceeded, the accumulation buffer operates (in the second (“overflow”) mode of operation) to evict render output data for a (each) compression unit to the encoder as soon as all of the render output data that a (current) rendering tile will generate for the compression unit has been accumulated in the accumulation buffer (e.g. as opposed to waiting for the accumulation buffer to become full (overflow), or waiting to accumulate all of the render output data for the compression unit that will be generated by the rendering circuit as multiple separate rendering tiles, e.g. as in the first (“accumulation”) mode of operation).

As will be discussed in more detail below, this can reduce processing delays, and facilitate improved processing efficiency.

It will be appreciated therefore, that the technology described herein can provide improved tile-based graphics processing.

The graphics processing system comprises a (tile-based) graphics processor (GPU). The graphics processing system may further comprise a host processor, e.g. a central processing unit (CPU). The host processor (e.g. CPU) may execute applications that can require graphics processing by the graphics processor (GPU), and send appropriate commands and data to the graphics processor (GPU) to control it to perform graphics processing operations and to produce graphics processing (render) output required by applications executing on the host processor (CPU).

To facilitate this, the host processor (CPU) in embodiments also executes a driver for the graphics processor (GPU). Thus, in embodiments, the graphics processing system comprises a (tile-based) graphics processor (GPU) that is in communication with a host microprocessor (CPU) that executes a driver for the graphics processor (GPU).

The graphics processing system should, and in embodiments does, (further) comprise a memory system. The memory system may comprise any suitable and desired storage. The memory system may comprise on-chip memory (i.e. on the same chip as the host processor and/or the graphics processor) and/or external memory (i.e. not on the same chip as the host processor and/or the graphics processor). In embodiments, the memory system comprises a main (e.g. external) memory that the host processor and/or graphics processor are in communication with. The memory system may further comprise a cache system, via which the host processor and/or graphics processor can communicate with the main memory.

In embodiments of the technology described herein, the graphics processing system/processor is operable to perform tile-based graphics processing, e.g. and in embodiments, in order to generate a render output, such as a frame for display. The graphics processing system/processor should thus, and in embodiments does, generate an overall render output on a tile-by-tile basis. The render output (area) should thus be, and in embodiments is, divided into plural rendering tiles for rendering purposes.

In embodiments, the tile-based graphics processor generates a (the) render output (e.g. frame for display) by performing a first (geometry, e.g. tiling) processing pass and a second (e.g. fragment) processing pass. In embodiments, the first (geometry) processing pass prepares primitive information (data) for a set of primitives that indicates which primitives of the set to process (e.g. rasterise and render) for which rendering tiles that the render output is divided into, and the second (e.g. fragment) processing pass generates the rendering tiles (separately) by using the primitive information generated in the first processing pass to determine which primitives of the set to process (e.g. rasterise and render) for which of the rendering tiles.

A render output will typically comprise an array of data elements (sampling points) (e.g. pixels), for each of which appropriate render output data (e.g. a set of colour value data) is generated by the graphics processing system/processor. A render output data may comprise colour data, for example, a set of red, green and blue, RGB values and a transparency (alpha, a) value. Where the graphics processor generates plural (e.g. a series of) render outputs, each render output may be generated in accordance with the technology described herein.

The rendering tiles that a render output is divided into for rendering purposes can comprise any suitable and desired region (area) of the render output being generated. The rendering tiles are in embodiments all the same size and shape (i.e. regularly-sized and shaped tiles are in embodiments used), although this is not essential. The tiles are in embodiments rectangular, and in embodiments square (having a particular width and height). Each tile may comprise an appropriate array of contiguous data elements (sampling positions) of the render output, such as 16×16, 32×32 or 64×64 data elements (sampling positions) of the render output.

In embodiments, there are plural possible rendering tile sizes and/or shapes (e.g. widths and/or heights) (rendering configurations) that the graphics processor is configured to be able to use to generate a render output (e.g. frame for display).

The tile-based graphics processor (GPU) may be arranged in any suitable manner. In embodiments, the graphics processor (GPU) comprises one or more, e.g. plural, processing cores, which are (each) operable to perform graphics processing operations to generate rendering tiles of a render output. A (each) processing core may be (a shader core) operable to perform graphics processing operations by executing (e.g. shader) program instructions. There may be any suitable number of processing cores, such as 1, 2, 4, 8, 16, 32 or another number. In embodiments, a (each) processing core comprises one or more execution units (execution engines) that are operable to execute program instructions.

In embodiments, the tile-based graphics processor (GPU) (further) comprises one or more geometry processing units (e.g. tiling units) that perform the first (geometry, e.g. tiling) processing pass to generate primitive information, and the second (e.g. fragment) processing pass to generate the rendering tiles of a render output is performed by the one or more, e.g. plural, processing cores.

Thus, in embodiments, each processing (shader) core of the graphics processor is associated with, e.g. comprises, e.g. is, a respective rendering circuit that is operable to generate rendering tiles of render output data for a (the) render output. Thus, in embodiments, the graphics processor comprises a plurality of rendering circuits/processing cores that are operable to generate a render output together.

In embodiments, different rendering circuits/processing cores of the graphics processor can generate different rendering tiles (of the same render output) at the same time (in parallel). To facilitate this, in embodiments, different regions (“metatiles”) of a (the) render output are assigned to different rendering circuits/processing cores of the graphics processor for processing (e.g. in parallel).

The rendering regions can be any suitable regions of the render output. In embodiments, the render output is divided (for processing purposes) into non-overlapping and regularly sized and shaped rendering regions. In embodiments, each such rendering region encompasses a respective set of one or more (e.g. plural) contiguous rendering tiles of the render output. The rendering regions are thus, in embodiments, rectangular, and in embodiments square (having a particular width and height).

In embodiments, there are plural possible rendering region (“metatile”) sizes and/or shapes (e.g. widths and/or heights) (rendering configurations) that the graphics processor is configured to be able to use to (divide a render output between rendering circuits/processing cores to) generate a render output.

Thus, in embodiments, each rendering circuit/processing core of the graphics processor generates a respective group (“metatile”) of one or more, e.g. plural, rendering tiles of a (the same) render output (e.g. frame for display). In embodiments, a (each) rendering circuit/processing core generates the rendering tiles of a (respective) group (“metatile”) of rendering tiles separately, e.g. sequentially, one rendering tile after the other.

A (each) rendering circuit/processing core can be arranged in any suitable manner. In embodiments, a (each) rendering circuit/processing core is configured to execute a tile-based graphics processing pipeline to generate rendering tiles of a (rendering region of a) render output being generated. In embodiments, a (each) rendering circuit (pipeline) includes a rasteriser and a fragment renderer. In embodiments, the rasteriser receives primitives for a rendering tile, rasterises the primitives to fragments, and provides the fragments to the fragment renderer for processing. In embodiments, the fragment renderer is operable to perform fragment rendering to generate rendered fragment data, and may perform any appropriate fragment processing operations in respect of fragments generated by the rasteriser, such as texture mapping, blending, shading, etc..

In embodiments, the tile-based graphics processing system/processor (GPU) comprises one or more tile buffers for storing rendering tiles of a render output being generated. In embodiments, a tile buffer stores render output data for a rendering tile being rendered by (a rendering circuit/processing core of) the tile-based graphics processing system/processor, until the (rendering circuit/processing core of the) tile-based graphics processing system/processor completes the rendering of the rendering tile. In embodiments, rendered fragment data generated by the fragment renderer is written to a tile buffer.

Where the graphics processor comprises one or more (e.g. a plurality of) processing (shader) cores, each processing (shader) core in embodiments comprises a respective tile buffer, configured to store tiles (render output data) that have been generated by (the rendering circuit of) that (shader) core. Thus, the graphics processor may comprise a plurality of tile buffers. In embodiments, (the rendering circuit of) a (each) processing (shader) core is arranged to write tiles of data that it is processing to the tile buffer of the (respective) processing (shader) core.

A (each) tile buffer should be, and in embodiments is, provided local to (i.e. on the same chip as) a (the) tile-based graphics processor, for example, and in embodiments, as part of RAM that is located on (local to) the graphics processor (chip). A tile buffer may accordingly have a fixed storage capacity, for example corresponding to the render output data (e.g. for an array or arrays of sample values) that the tile-based graphics processor needs to store for (only) a single rendering tile until the rendering of that tile is completed. In embodiments, a tile buffer is able to store any (and all) tile sizes that the graphics processor may be configured to generate. Thus, the tile buffer is in embodiments able to store a largest tile of data that could be generated by the graphics processor.

Once a rendering tile is completed by (a rendering circuit/processing core of) the tile-based graphics processing system/processor, render output data for the rendering tile in embodiments is written out from the (respective) tile buffer to other storage that is in embodiments external to (i.e. on a different chip to) the tile-based graphics processor, such as (a frame buffer in) the (main) memory, for use. The graphics processor in embodiments includes a write-out circuit coupled to the tile buffer for this purpose.

Where the graphics processor comprises one or more (e.g. a plurality of) processing (shader) cores, each processing (shader) core in embodiments comprises a respective write-out circuit that is configured to write out render output data from a respective tile buffer (to the memory system). Thus, the graphics processor may comprise a plurality of write-out circuits. In embodiments, respective tiles of a render output being generated are stored in a tile buffer as they are being generated, and then written from the tile buffer towards (to) the memory system for storage (by a write-out circuit).

In embodiments, uncompressed render output tile data that is written out toward the memory system (by a write-out circuit) is encoded (by the encoder) using a block-based compression scheme before being stored in the memory system. In embodiments, the block-based compression scheme encodes compression units (blocks) of uncompressed render output data having a particular size and/or shape for storing in the memory system in a compressed format.

Where the graphics processor comprises one or more (e.g. a plurality of) processing (shader) cores, each processing (shader) core in embodiments comprises a respective encoder that is configured to encode (compress) render output data (provided by the respective write-out circuit). Thus, the graphics processor may comprise a plurality of encoders.

An (each) encoder can be configured to use any suitable and desired block-based encoding (compression) technique. The compression scheme may encode data in a lossless or lossy manner, and using variable or fixed-rate compression. The encoder may support and be configured to be able to perform a plurality of different forms of block-based encoding, which may, e.g., and in embodiments, be set in use (e.g. on an output-by-output basis).

The block-based encoding (compression) scheme that an (each) encoder is configured to perform should be, and in embodiments is, configured to compress input blocks (compression units) having a particular size and/or shape. Thus, the input to the encoding process will be a block (a data array) having a particular size and/or shape, which the encoding process will then compress to provide an output compressed data block corresponding to that input (uncompressed) data block.

Thus, for any given render output being generated, each compression unit that is compressed should, and in embodiments does, comprise an appropriate subset of the data elements (positions) of the render output (data array), i.e. corresponding to a particular region of the render output. Correspondingly, the render output is in embodiments divided (for encoding purposes) into non-overlapping and regularly sized and shaped compression units (blocks) (regions).

The compression units (blocks) that are encoded (compressed) may be any suitable size and shape. In embodiments, they are rectangular (having a particular width and height). The compression units (blocks) may be square, but in embodiments are non-square rectangles.

In embodiments an (each) encoder can be configured and set to compress different sized and shaped input blocks, for example, and in embodiments, on an output-by-output basis. For example, the compression unit size and shape for a render output (or sequence of render outputs) may be set by an application that is using, or by a driver for, the graphics processing system.

While it could be the case that the size and shape of the compression units to be used for a given render output being generated correspond exactly to the size and shape of the rendering tiles that are being generated (in which case each tile may simply be compressed as a respective compression unit), the compression units for a given render output may not match the tile size and/or shape. For example, if the tile size is larger than a compression unit, then each compression unit may comprise a respective part (portion) comprising some but not all of a tile. Conversely, if the tile size is smaller than a compression unit then each compression unit may comprise all and/or respective parts (portions) of a plurality of tiles.

In embodiments, to account for such potential mismatches between compression unit and rendering tile size and/or shape, an (the) accumulation buffer is provided intermediate (in the data path from) a write-out circuit and an encoder. In embodiments, the accumulation buffer receives data of tiles from a tile buffer/write-out circuit, and outputs that data to the encoder as data arrays corresponding to the (uncompressed) data array size that the block-based compression scheme of the encoder uses. In other words, the accumulation buffer is in embodiments configured to (try to) ensure that the encoder receives an appropriate “complete” block of render output data (a complete “compression unit”) for encoding (compressing) and writing out to the memory system.

Where the graphics processor comprises one or more (e.g. a plurality of) processing (shader) cores, each processing (shader) core in embodiments comprises a respective accumulation buffer (configured to receive and accumulate render output data from the respective write-out circuit/tile buffer and (try to) provide complete compression units to the respective encoder for encoding). Thus, the graphics processor may comprise a plurality of accumulation buffers.

In embodiments, the graphics processor comprises a plurality of processing (shader) cores, with each processing (shader) core comprising a respective rendering circuit, encoder and accumulation buffer.

An (each) accumulation buffer can be configured in any suitable and desired manner. In embodiments an accumulation buffer comprises storage for storing render output data received from a (respective) write-out circuit/tile buffer before that data is provided to an (respective) encoder. In embodiments, the storage for the accumulation buffer is set aside for, and dedicated to, the accumulation buffer, and, e.g., and in embodiments, is not part of (is other than part of) any cache system or cache hierarchy of the graphics processor and memory system.

In embodiments, an (each) accumulation buffer is able to store render output data for plural, different compression units (that it is accumulating) at the same time. In embodiments, the accumulation buffer maintains a record of the compression units that it is currently storing (accumulating), and keeps track of what data for a (and each) compression unit the accumulation buffer currently stores.

The allocation of storage for compression units in an accumulation buffer can be performed in any suitable and desired manner. In embodiments, when the (respective) write-out circuit is writing render output data from the (respective) tile buffer to the (respective) accumulation buffer, the accumulation buffer identifies which compression unit the render output data is for (based on an appropriate indication of this from the write-out circuit, for example), and determines whether it is currently accumulating render output data for that compression unit or not. In embodiments, when the compression unit in question is already being accumulated by the accumulation buffer, then the accumulation buffer will store the new render output data for that compression unit appropriately in its storage (and update its record of stored data for that compression unit accordingly). On the other hand, when the accumulation unit is not currently storing any render output data for the compression unit in question (i.e. a new compression unit has been started), the accumulation buffer in embodiments first allocates storage for that new compression unit (and a corresponding entry in its compression unit record), and then starts storing (and tracking) the render output data for that new compression unit.

An (each) accumulation buffer is operable to provide render output data (e.g. in the form of complete compression units) to an (respective) encoder (to write data out from the accumulation buffer storage to the encoder) for the encoder to then encode as respective compression units (blocks). In embodiments of the technology described herein, this operation to “evict” a compression unit from the accumulation buffer storage to the encoder for encoding can be triggered in a manner that depends on a mode of operation that the graphics processor is operating in.

In embodiments, the graphics processing system comprises a processing circuit operable to select a mode of operation (from at least a first (“accumulation”) mode of operation and a second (“overflow”) mode of operation), and cause the graphics processor to operate in the selected mode of operation. The (mode-selecting) processing circuit may be or form part of the host processor (e.g. the driver), the graphics processor, or another element of the system.

In embodiments, when operating in the first (“accumulation”) mode of operation, render output data for a compression unit is evicted from the accumulation buffer (to the encoder) when and once the accumulation buffer has accumulated (is storing data for) the entire compression unit in question.

However, the Applicants have recognised that it is possible that not all of a given compression unit may be generated and output via the same tile buffer/write-out circuit (e.g. rendering circuit/processing core) of the graphics processor. In this case, a complete compression unit may never be accumulated in the accumulation buffer associated with the tile buffer/processing core in question.

To account for this, in embodiments, it is also possible to trigger the eviction of an “incomplete” compression unit from the accumulation buffer (storage). To facilitate this, in embodiments, when operating in the first (“accumulation”) mode of operation, render output data for a compression unit is evicted from an accumulation buffer (to an (respective) encoder) in response to an (first) indication that all of the render output data for the compression unit that a (respective) rendering circuit/processing will generate for a render output has been accumulated by the accumulation buffer.

For example, and in embodiments, where the rendering circuit of a (each) processing core generates a respective rendering region (“metatile”) of one or more, e.g. plural, rendering tiles of a render output, render output data for a compression unit may be evicted from the accumulation buffer (of the (respective) processing core) to the encoder (of the (respective) processing core) in response to a first indication that all of the render output data for the compression unit that the rendering circuit will generate for the respective rendering region (“metatile”) (e.g. group of plural rendering tiles) has been accumulated by the accumulation buffer.

In embodiments, the first indication is an indication that the final piece of render output data (sampling position/pixel) that will be generated for a given (the) compression unit by the (respective) rendering circuit/processing core has been written to the (respective) accumulation buffer. For example, and in embodiments, the first indication may be an indication that the final piece of render output data that will be generated by the final rendering tile of the (respective) rendering region (“metatile”) that the (respective) rendering circuit will generate has been written to the (respective) accumulation buffer.

Thus, for example and in embodiments, when operating in the first (“accumulation”) mode of operation, a (each) compression unit that overlaps plural different rendering tiles that belong to the same rendering region (“metatile”) and are generated by the same processing core/rendering circuit may be subject to (only) one eviction operation, e.g. once all of the plural different rendering tiles that the compression unit overlaps have been generated by the (respective) processing core/rendering circuit (and written to the accumulation buffer).

In embodiments, when operating in the second (“overflow”) mode of operation, render output data for a (“incomplete”) compression unit is evicted from an accumulation buffer (to an (respective) encoder) in response to an (second) (different) indication that all of the render output data for the compression unit that (only) a single rendering tile will generate has been accumulated by the accumulation buffer.

For example, and in embodiments, where the rendering circuit of a (each) processing core generates a respective rendering region (“metatile”) of one or more, e.g. plural, rendering tiles of a render output, render output data for a compression unit may be evicted from the accumulation buffer (of the (respective) processing core) to the encoder (of the (respective) processing core) in response to a second indication that all of the render output data for the compression unit that (only) a single rendering tile of the respective rendering region (“metatile”) (e.g. group of plural rendering tiles) generates has been accumulated by the accumulation buffer.

In embodiments, the second indication is an indication that the final piece of render output data (sampling position/pixel) that will be generated for a given (the) compression unit by (only) a single rendering tile has been written to the (respective) accumulation buffer.

Thus, for example and in embodiments, when operating in the second (“overflow”) mode of operation, a (each) compression unit that overlaps plural different rendering tiles (that belong to the same rendering region (“metatile”) and are generated by the same processing core/rendering circuit) may be subject to plural eviction operations, e.g. each time one of the plural different rendering tiles that the compression unit overlaps is generated by the (respective) processing core/rendering circuit (and written to the accumulation buffer).

Thus, in embodiments, when operating in the first (“accumulation”) mode of operation, render output data for a (any given) compression unit may be provided (evicted) by an accumulation buffer to an encoder (and encoded) on a “per-rendering region” basis, once per rendering region (“metatile”) (that the compression unit overlaps). In embodiments, when operating in the second (“overflow”) mode of operation, render output data for a (any given) compression unit may be provided (evicted) by an accumulation buffer to an encoder (and encoded) on a “per-rendering tile” basis, once per rendering tile (that the compression unit overlaps), and e.g. multiple times per rendering region (“metatile”) that the compression unit overlaps. Thus, in embodiments, compression unit evictions occur at a higher frequency in the second (“overflow”) mode of operation than in the first (“accumulation”) mode of operation.

An (first and/or second) indication that triggers a compression unit eviction may be provided in any suitable manner. In embodiments, an indication is provided by a (each) write-out circuit, e.g. when providing render output data to an (respective) accumulation buffer.

In embodiments, when operating in the first (“accumulation”) mode of operation, a (each) write-out circuit when providing render output data to an (respective) accumulation buffer indicates when (whether) a sampling position (pixel) that is being provided to the accumulation buffer from the (respective) tile buffer is the last sampling position pixel (the last piece of render output data) for the compression unit in question that will be generated for the render output by the processing (shader) core/rendering circuit that the tile buffer relates to.

In embodiments, when operating in the second (“overflow”) mode of operation, a (each) write-out circuit when providing render output data to an (respective) accumulation buffer indicates when (whether) a sampling position (pixel) that is being provided to the accumulation buffer from the (respective) tile buffer is the last sampling position pixel (the last piece of render output data) for the compression unit in question that will be generated by the (current) rendering tile.

An (first and/or second) indication can be provided from the write-out circuit to the accumulation buffer in any suitable and desired manner, for example as appropriate sideband signalling, and/or as metadata associated with the render output data, etc.. Equally, it could for example, be indicated explicitly for each individual piece of render output data (sampling position/pixel) that is provided to the accumulation buffer, which compression unit that data relates to, or only changes in the compression unit that the render output data relates to could be indicated, for example. Other arrangements are possible.

A (each) write-out circuit may be able to determine whether a piece of render output data it is writing is a last piece in any suitable and desired manner. For example, suitable parameters, such as the size and/or the configuration of the compression units that the data encoder is to encode for the render output in question, the size and configuration of the output (data array) being generated, and/or the positions and/or size and configuration of tiles within the output being generated may be provided to the write-out circuit, so that the write-out circuit can determine for any given tile which compression unit data of the tile belongs to. The write-out circuit may also be, for example, provided with a list of tiles being processed by the processing (shader) core in question, and/or the region of the render output that has been allocated to that processing core, so again it can be determined when the final render output data for a given compression unit for the render output/rendering tile is being written out. This information may be provided, for example, and in embodiments, by the driver for the graphics processor that is controlling and initiating the generation of the render output in question by the graphics processor. Other arrangements are possible.

In embodiments, an (each) accumulation buffer has a (maximum) storage capacity. In embodiments, the graphics processor is operable to generate a render output using one of a plurality of different possible rendering configurations (e.g. each possible rendering configuration being associated with a particular rendering tile size and/or shape, and/or a rendering region (“metatile”) size and/or shape, and/or a compression unit size and/or shape), and the (maximum) storage capacity of an (each) accumulation buffer is (only) sufficient to accumulate render output data when generating a render output using some but not all of the plurality of different possible rendering configurations.

For example, and in embodiments, an (each) accumulation buffer may (only) be able to accumulate render output data for a particular maximum number of compression units at any one time, such as 10, 20, or another number of, compression units, and e.g. there is at least one rendering configuration that is such that a (each) rendering tile overlaps more than the particular maximum number of compression units.

In embodiments, when an accumulation buffer is full (e.g. when the accumulation buffer is accumulating render output data for the maximum number of compression units), and the (respective) write-out circuit (tries to) writes out render output data for a new compression unit to the accumulation buffer, render output data for a (already accumulating) compression unit may be evicted from the accumulation buffer (to the (respective) encoder), e.g. so as to free up storage for the new compression unit.

However, in embodiments, when it is known that the (maximum) capacity of an accumulation buffer will be exceeded, the graphics processor operates in the second mode of operation, e.g. so as to try to free up storage earlier. Thus, in embodiments, it is determined (e.g. by the (mode-selecting) processing circuit) whether the (maximum) capacity of the accumulation buffer will be exceeded, and when it is determined that the (maximum) capacity of the accumulation buffer will be exceeded, the graphics processor is caused (e.g. by the (mode-selecting) processing circuit) to operate in the second (“overflow”) mode of operation. In embodiments, when it is not determined that the (maximum) capacity of the accumulation buffer will be exceeded (e.g. when it is determined that the (maximum) capacity of the accumulation buffer will not be exceeded), the graphics processor is caused (e.g. by the (mode-selecting) processing circuit) to operate in the first (“accumulation”) mode of operation.

It may be determined whether the (maximum) capacity of an (the) accumulation buffer will be exceeded in any suitable manner. In embodiments, before beginning generating a (new) render output, it is predicted (e.g. by the (mode-selecting) processing circuit) whether the (maximum) capacity of an accumulation buffer will be exceeded when generating the render output, and when it is predicted (before beginning the render output) that the (maximum) capacity of the accumulation buffer will be exceeded, the (entire) render output is generated operating in (using) the second (“overflow”) mode of operation. In embodiments, when it is not predicted (before beginning the render output) that the (maximum) capacity of the accumulation buffer will be exceeded, the (entire) render output is generated operating in (using) the first (“accumulation”) mode of operation.

It may be predicted (e.g. by the (mode-selecting) processing circuit), before beginning generating a (new) render output, whether the (maximum) capacity of an accumulation buffer will be exceeded when generating the render output in any suitable manner. In embodiments, information indicating a rendering configuration that will be used to generate the render output (e.g. comprising one or more descriptors) is used to predict whether the (maximum) capacity of the accumulation buffer will be exceeded when generating the render output. For example, it may be determined (using the information, e.g. descriptors) whether a (each) rendering tile will overlap more than the maximum number of compression units that the accumulation buffer can accumulate at the same time, and when this is the case, it may be determined that the (maximum) capacity of the accumulation buffer will be exceeded.

In embodiments, a lookup table is used to predict (determine) whether the (maximum) capacity of the accumulation buffer will be exceeded. In embodiments, the lookup table relates rendering configuration parameters (such as rendering region size and/or shape, rendering tile size and/or shape, compression unit size and/or shape, rendering tile processing order, etc.) to associated accumulation buffer capacities (memory footprints). In embodiments, the lookup table is used to determine an accumulation buffer capacity associated with a rendering configuration, and the determined accumulation buffer capacity is compared with an actual accumulation buffer capacity to determine whether the (maximum) capacity of the accumulation buffer will be exceeded.

The Applicants have found, however, that predicting whether the (maximum) capacity of an accumulation buffer will be exceeded can be complex and expensive to implement. In embodiments, therefore, rather than trying to predict whether the (maximum) capacity of an accumulation buffer will be exceeded before beginning generating a (new) render output, it is initially assumed that the (maximum) capacity of an accumulation buffer will not be exceeded, and then it is determined whether the (maximum) capacity is actually exceeded when generating the render output.

Thus, in embodiments, when beginning generating a (new) render output, the graphics processor is caused (e.g. by the (mode-selecting) processing circuit) to operate in the first (“accumulation”) mode of operation. At least a first rendering tile of the render output will therefore at least begin being generated while the graphics processor is operating in the first (“accumulation”) mode of operation. In embodiments, if, while generating the render output, a threshold (e.g. maximum) capacity of an accumulation buffer is exceeded, the graphics processor is caused (e.g. by the (mode-selecting) processing circuit) to switch to operating in the second (“overflow”) mode of operation until generation of the render output is complete.

Thus, in embodiments, if, while generating the render output, the threshold (e.g. maximum) capacity of an accumulation buffer is exceeded, the graphics processor will switch to operating in the second mode of operation, and the remainder of the (rendering tiles of the) render output will be generated operating in (using) the second (“overflow”) mode of operation. On the other hand, in embodiments, if, while generating the render output, the threshold (e.g. maximum) capacity of an accumulation buffer is not exceeded, the graphics processor will remain operating in the first mode of operation, and the (entire) render output will be generated operating in (using) the first (“accumulation”) mode of operation.

It is believed that the idea of beginning the generation of a render output in a first mode of operation, and switching to a second mode of operation in response to accumulation buffer overflow, may be novel and inventive in its own right.

Accordingly, another embodiment of the technology described herein comprises a method of operating a tile-based graphics processor or a graphics processing system that includes a tile-based graphics processor; wherein the graphics processor is operable to generate a render output and comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
the method comprising:
when beginning generating a (new) render output: causing the accumulation buffer to provide render output data for a compression unit to the encoder for encoding in accordance with a first mode of operation; and
in response to a threshold (e.g. maximum) capacity of the accumulation buffer being exceeded while generating the render output: causing the accumulation buffer to provide render output data for a compression unit to the encoder for encoding in accordance with a second, different mode of operation until generation of the render output is complete.

Another embodiment of the technology described herein comprises a tile-based graphics processor or a graphics processing system that includes a tile-based graphics processor; wherein the graphics processor is operable to generate a render output and comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
wherein the processor or system is operable to:
when beginning generating a (new) render output: cause the accumulation buffer to provide render output data for a compression unit to the encoder for encoding in accordance with a first mode of operation; and
in response to a threshold (e.g. maximum) capacity of the accumulation buffer being exceeded while generating a render output: cause the accumulation buffer to provide render output data for a compression unit to the encoder for encoding in accordance with a second, different mode of operation until generation of the render output is complete.

These embodiments can, and in embodiments do, include one or more, and in embodiments all, features of other embodiments of the technology described herein, as appropriate. For example, and in embodiments, in the first mode of operation the accumulation buffer provides render output data for a compression unit to the encoder for encoding in response to an (first) indication that all render output data for the compression unit that the rendering circuit will generate for the render output has been accumulated by the accumulation buffer. In embodiments, in the second mode of operation, the accumulation buffer provides render output data for a compression unit to the encoder for encoding in response to an (second, different) indication that all render output data for the compression unit that the rendering circuit will generate for a single rendering tile of the render output has been accumulated by the accumulation buffer.

Accordingly, another embodiment of the technology described herein comprises a method of operating a tile-based graphics processor/processing system that is operable to generate a render output; wherein the graphics processor comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
the method comprising:
when beginning generating a (new) render output: causing the graphics processor to operate in a first mode of operation in which the accumulation buffer will provide render output data for a compression unit to the encoder for encoding in response to an indication that all render output data for the compression unit that the rendering circuit will generate for the render output has been accumulated by the accumulation buffer; and
in response to a threshold (e.g. maximum) capacity of the accumulation buffer being exceeded while generating the render output: causing the graphics processor to switch to operating in a second mode of operation in which the accumulation buffer will provide render output data for a compression unit to the encoder for encoding in response to an indication that all render output data for the compression unit that the rendering circuit will generate for a single rendering tile of the render output has been accumulated by the accumulation buffer (until generation of the render output is complete).

Another embodiment of the technology described herein comprises a tile-based graphics processor/processing system operable to generate a render output; the graphics processor comprising:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
wherein the graphics processor is operable to:
when beginning generating a (new) render output: operate in a first mode of operation in which the accumulation buffer will provide render output data for a compression unit to the encoder for encoding in response to an indication that all render output data for the compression unit that the rendering circuit will generate for a render output has been accumulated by the accumulation buffer; and
in response to a threshold (e.g. maximum) capacity of the accumulation buffer being exceeded while generating a render output: switch to operating in a second mode of operation in which the accumulation buffer will provide render output data for a compression unit to the encoder for encoding in response to an indication that all render output data for the compression unit that the rendering circuit will generate for a single rendering tile of a render output has been accumulated by the accumulation buffer (until generation of the render output is complete).

These embodiments can, and in embodiments do, include one or more, and in embodiments all, features of other embodiments of the technology described herein, as appropriate.

Once an eviction process has been triggered, the eviction process can proceed in any suitable and desired manner. In embodiments, the eviction process first determines whether a complete or incomplete compression unit is being evicted from the accumulation buffer to the encoder. Thus, in embodiments, the eviction process comprises determining for a compression unit to be evicted, whether the accumulation buffer has accumulated (stores) all of the render output data for that compression unit. In the case where all of the render output data for the compression unit to be evicted is stored by the accumulation buffer, then the complete compression unit can be, and in embodiments is, provided to the encoder for encoding. In the case where not all of the render output data for the compression unit to be evicted is stored by the accumulation buffer, in embodiments, the accumulation buffer fetches any missing render output data that is required for (to complete) the compression unit from the memory system.

Thus, in embodiments, the compression unit eviction process (for sending a compression unit to the encoder) comprises (first) determining for the compression unit to be evicted, whether the accumulation buffer stores all of the render output data for that compression unit, and in the case that not all of the render output data for the compression unit to be evicted is stored by the accumulation buffer, the accumulation buffer fetching the missing render output data for the compression unit (from the memory system), and when it has received the missing render output data for the compression unit, then providing the complete (entire) compression unit to the encoder for encoding.

The above describes the main elements and operation of the graphics processor and graphics processing pipeline that are relevant to operation in the manner of the technology described herein.

As will be appreciated by those skilled in the art, the graphics processor can otherwise include and execute, and in embodiments does include and execute, any one or one or more, and in embodiments all, of the processing stages and circuits that graphics processors and graphics processing pipelines may (normally) include.

In embodiments, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output being generated may comprise any output that can and is to be generated by the graphics processor and processing pipeline. The technology described herein can be used for all forms of output that a graphics processor and processing pipeline may be used to generate, such as frames for display, render-to-texture outputs, etc.. In embodiments, the output is an output frame, and in embodiments an image.

In embodiments, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc..

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described with reference to the drawings.

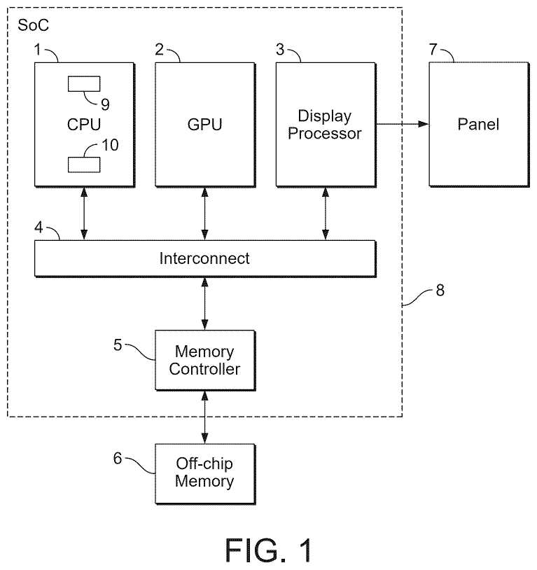

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

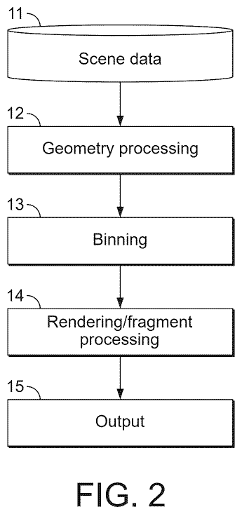

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in embodiments, by storing it in the memory 6 from where it can then be read by the graphics processor 2.

This scene data 11 may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing 12 comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing 12 and, for example, to be triggered at the binning or rendering stages instead, if desired.

As well as appropriate vertex shading, the geometry processing 12 may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing 12 has been performed, there is then, in the present embodiments, as shown in FIG. 2, a binning/tiling stage 13. The graphics processor 2 in the present embodiments is a tile-based graphics processor and so generates respective output tiles of an overall output (e.g. frame) to be generated separately to each other, with the set of tiles for the overall output then being appropriately combined to provide the final, overall output.

The binning process 13 operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing 12 and/or the binning/tiling operation 13 the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing 12 and/or as part of the binning/tiling processing 13, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage 13.

Once the binning/tiling process 13 has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing 14 can comprise any suitable and desired rendering and fragment processing operations that may be performed. Thus it may comprise, for example, first rasterising primitives to be processed for a tile to fragments, and then processing those fragments accordingly (e.g., and in embodiments, by performing appropriate fragment shading of the fragments). The rendering/fragment processing 14 may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing 14 (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array 15 may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc..

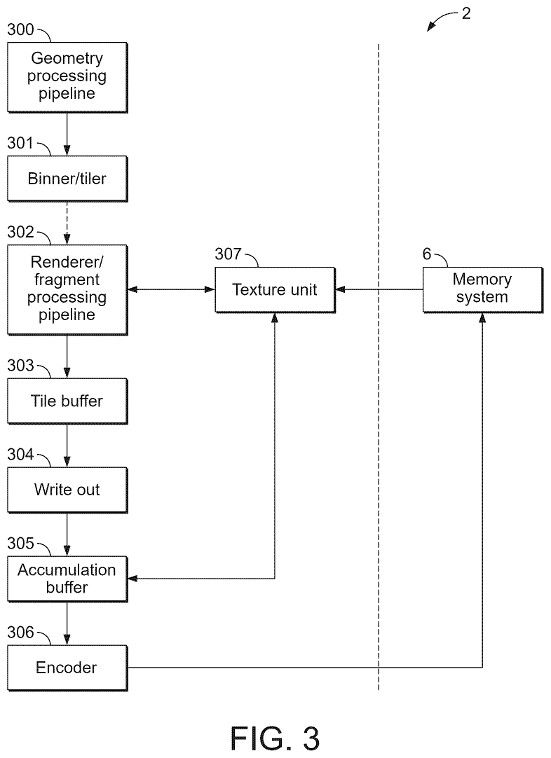

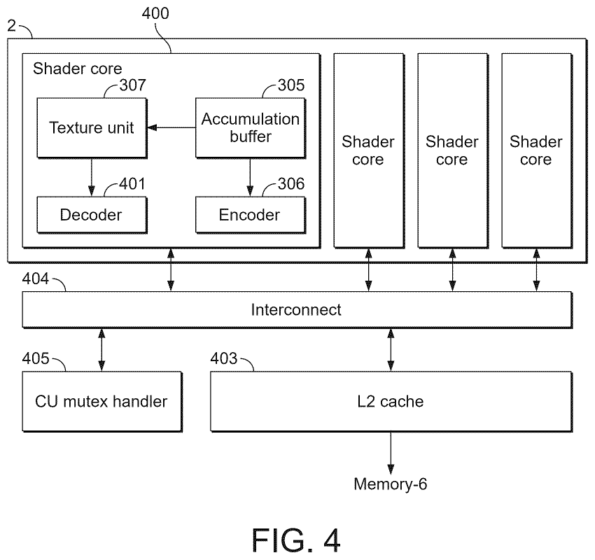

FIGS. 3 and 4 show in more detail an embodiment of a graphics processor (GPU) 2 that can execute a graphics processing pipeline of the form shown in FIG. 2, and that can be operated in the manner of the technology described herein.

FIGS. 3 and 4 shows the particular elements and units of the graphics processor in the present embodiments that are relevant to operation in the manner of the technology described herein. It will be appreciated that the graphics processor may, and typically will, comprise other elements and components that are not shown in FIGS. 3 and 4.

As shown in FIG. 3, the graphics processor 2 in the present embodiments comprises appropriate processing circuits operable to execute a geometry processing pipeline 300 to perform the geometry processing operations as discussed above with reference to step 12 of FIG. 2. In the present embodiments, this geometry processing pipeline is implemented and the geometry processing performed by executing appropriate geometry processing shader programs in a programmable processing (shader) core or cores of the graphics processor 2. Other arrangements, such as having a fixed function geometry processing pipeline would be possible, if desired.

There is then a binning/tiling circuit or circuits (binner/tiler) 301, that performs the binning process discussed above with reference to step 13 of FIG. 2.

The graphics processor 2 then comprises appropriate processing circuits to execute a rendering/fragment processing pipeline 302 (step 14 of FIG. 2). Again in the present embodiments, the fragment processing pipeline 302 is implemented by executing appropriate fragment processing shader programs on a shader core or cores of the graphics processor 2, but fixed function fragment processing could also be performed, if desired.

In the present embodiments, as the graphics processor 2 is a tile-based graphics processor, the fragment processing pipeline 302 operates on and to generate respective tiles of an output being generated, and so correspondingly writes the output for a tile or tiles that it is generating to a tile buffer 303 which stores the tile data locally while a tile is being processed.

Once the processing for a tile has been finished, it can then be written out from the tile buffer by a write-out circuit 304 towards the memory system 6.

As shown in FIG. 3, the tile data is written out from the tile buffer in the present embodiments via an accumulation buffer 305 and an encoder 306. The operation of the accumulation buffer 305 and encoder 306 in the present embodiments will be described in more detail below.

As also shown in FIG. 3, the fragment processing pipeline 302 has access to a texture unit (texture mapper) 307 which is operable to perform texturing operations on texture data stored in the memory system 6 and to provide the results of those texturing operations to the fragment processing pipeline 302 for use.

As shown in FIG. 3, the accumulation buffer 305 also has an interface to and can communicate with the texture unit (texture mapper) 307. This operation will again be discussed in more detail below.

FIG. 4 shows further elements of the graphics processor 2 in the present embodiments in more detail. In particular, FIG. 4 shows in more detail the configuration of the processing (shader) cores in the graphics processor 2 in the present embodiments.

As shown in FIG. 4, the graphics processor 2 comprises a plurality of shader cores 400, with each shader core having its own respective texture unit 307, accumulation buffer 305 and encoder 306.

As shown in FIG. 4, each shader core 400 in the present embodiments also includes a corresponding decoder 401 that is operable to decode data that is stored in a compressed form in the memory for provision to the texture unit 307. Although the encoder 306 and decoder 401 are shown as separate components in FIG. 4, it will be appreciated that they can be provided in the form of a combined encoder/decoder (codec) if desired.

It will also be appreciated that the shader cores 400 in the graphics processor 2 in the present embodiments can and will include other components not shown in FIG. 4, such as a programmable execution unit for executing program instructions to perform graphics processing operations, etc., that are necessary for the operation of a shader core to execute shader programs to perform processing operations.

FIG. 4 also shows that the shader cores and in particular the encoder 306 and texture unit 307 of each shader core are operable to and configured to communicate with the memory system 6 via an appropriate cache hierarchy, including in particular an L2 cache 403. (Other cache hierarchy arrangements would be possible, such as comprising multiple cache levels, if desired.)

An appropriate interconnect 404 is provided to allow the shader cores to communicate with the L2 cache 403 and thus the memory 6.

FIG. 4 also shows a mutex handler 405 that is in communication with the shader cores 400 of the graphics processor. The mutex handler 405 maintains a set of mutexes, including a respective mutex for each compression unit that a shader core of the graphics processor is currently generating data for. Each mutex can be assigned to the accumulation buffer of only one shader core at any one time. The mutex handler 405 keeps track of the identity of the accumulation buffer (if any) that a mutex is currently assigned to. The operation of the mutex handler 405 in the present embodiments will be discussed in more detail below.

The data decoder 401 is operable to decompress data received from the memory 6 for use by the texture unit 307 of the graphics processor 2.

The encoder 306 is operable to compress (tile) data from the accumulation buffer 305 prior to sending that data to the memory 6 (via the L2 cache 403).

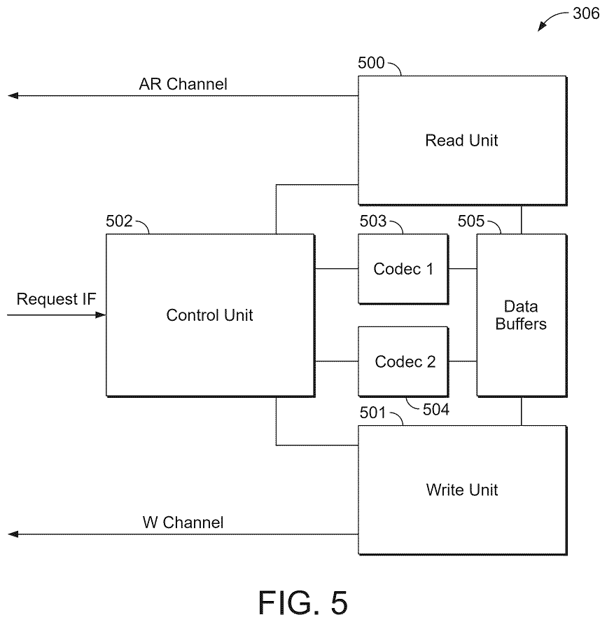

FIG. 5 shows an embodiment of the data encoder 306 in the present embodiments. As shown in FIG. 5, the (and each) data encoder 306 includes respective read 500 and write 501 units (circuits) that are operable to, respectively, receive data from the accumulation buffer 305, and write data to the L2 cache 403 (and thus to the memory system 6).

The data encoder 17 also includes an appropriate control unit (circuit) 502 that receives requests for encoding and controls the data encoder 306 to respond to those requests accordingly and appropriately.

As shown in FIG. 5, the data encoder 306 also includes one or more codecs 503, 504, and a set of data buffers 505 for temporarily storing data in the data encoder 306 while that data is processed.

The data encoder 306 can include any desired number of codecs, e.g. that are each respectively operable to perform a different encoding (compression) scheme. For example, one codec may be configured to perform an appropriate variable rate compression scheme, with the other codec being configured to perform an alternative, e.g. fixed rate compression scheme.

Other arrangements would be possible.

In the present embodiments, the encoder 306 is configured to and operable to perform block-based encoding, i.e. in which input data arrays of a particular “block” (compression unit) size are encoded (compressed) as respective compression units.

Thus the encoder will take as an input compression units of a particular data size (comprising data arrays of a particular size (W×H)), and then compress each such compression unit to provide a compressed output corresponding to the compression unit in question. Any given render output will accordingly be divided into an array of compression units of the particular size, with each such compression unit then being compressed and output independently.

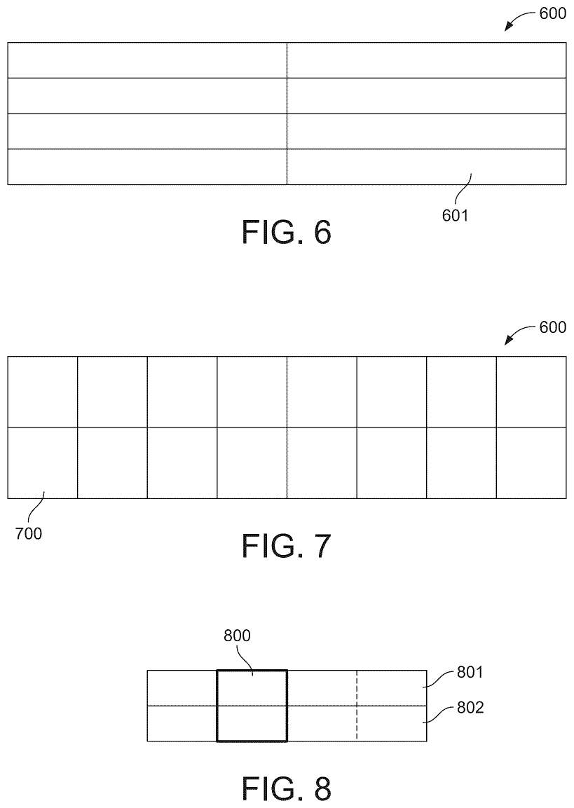

FIG. 6 illustrates this, and shows an exemplary output, such as a frame (image) 600 organised and stored in memory as a 2×4 array of 64×8 pixel (sampling position) compression units 601.

The compression unit size that the encoder 306 uses may be fixed, e.g. such that each different codec of the encoder 306 has its own, fixed compression unit size. Alternatively the encoder 306 may be operable to handle different sizes of input compression unit, for example with the particular size of compression unit to be used being set in use, for example on a (render) output-by-output basis.

As discussed above, in the present embodiments, the graphics processor 2 is a tile-based graphics processor, and thus operates to generate a given render output, such as a frame (an image), as respective tiles, which are typically square.

FIG. 7 illustrates this, and shows the corresponding tiles 700 that are generated when generating the frame (image) 600 shown in FIG. 6. It can be seen that the image 600 is generated as an array of 8×2 tiles, with each tile being 16×16 pixels (sampling positions) in size (in this example).

It will be appreciated from FIGS. 6 and 7 that a given 16×16 rendering tile produced by the graphics processor will potentially cover only part of one or more of the compression units 601 that the encoder encodes for the output 600. FIG. 8 illustrates this, and shows an exemplary tile 800 forming only part of two respective compression units 801, 802.

As shown in FIG. 8, the compression units 801, 802 will in fact comprise respective parts from four of the rendering tiles that will be generated when rendering the output frame (image) 600. Thus in such cases, it will not be possible for the encoder simply to compress a rendering tile as and when that rendering tile is completed, as the rendering tile will not match the (size of) the compression unit that the encoder compresses.

The present embodiments address this issue of the tile size (potentially) not matching the compression block (compression unit) size that the encoder 306 requires for its encoding process in a tile-based graphics processor.

In particular, in the present embodiments, and as shown in FIGS. 3 and 4, the graphics processor of the technology described herein includes an accumulation buffer 305 intermediate the tile write-out circuit 304 and the encoder 306, such that tiles will be written from the tile buffer 303 to the accumulation buffer 305, with the accumulation buffer then providing appropriate entire compression blocks (compression units) of tile data for compression to the encoder 306.

This then allows the encoder 306 simply to operate on and compress “complete” compression units, such that the encoder has no need, for example, to be able to perform partial compression of compression units, or to itself retrieve additional data for providing a “complete” compression unit for compression.

To facilitate this operation, the accumulation buffer 305 is configured to be able to store tile data from the tile buffer for plural compression units at the same time, so it can correspondingly accumulate tile data for plural compression units at the same time. The accumulation buffer 305 tracks the data that it is storing for all the compression units that it is currently storing, for example in the form of an appropriate compression unit tracking table.

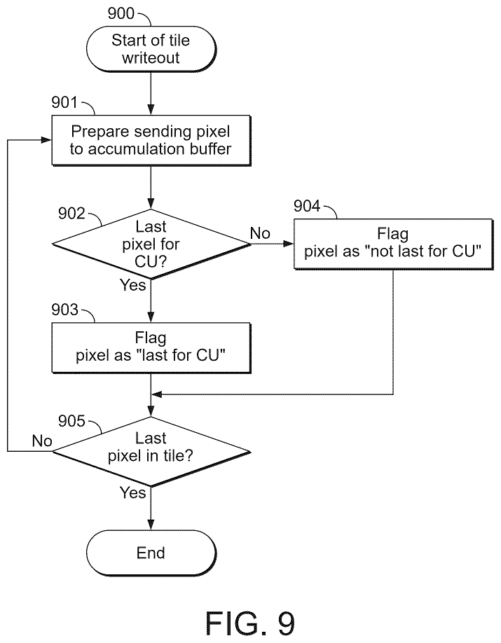

FIGS. 9-12 show the operation of the write-out circuit 304, accumulation buffer 305 and encoder 306 of a given shader core.

In the present embodiments, and as shown in FIG. 4, each shader core 400 has its own respective accumulation buffer 305 and encoder 306. Thus each shader core operates independently of the other shader cores in terms of the compression unit accumulation and encoding process.

Each shader core of the graphics processor (that has an accumulation buffer and encoder) may thus operate in the manner shown in FIGS. 9-12.

FIG. 9 shows the operation of the write-out unit (circuit) 304 when writing a finished tile out from the tile buffer 303.

When a tile is ready to be written from the tile buffer to the accumulation buffer 305 by the writeback unit 304 (step 900), the writeback unit indicates to the accumulation buffer which compression unit(s) the pixels (sampling positions) of the tile relate to. The accumulation buffer determines whether it is already accumulating data for the indicated compression unit(s), and if so, then the write of the sampling positions (pixels) from the tile buffer to the accumulation buffer is allowed to proceed (step 901).

When the tile data relates to a new compression unit, appropriate accumulation buffer storage for that new compression unit is allocated, together with an entry in the compression unit tracking table, before the data is then written to the accumulation buffer (step 901). The storage allocated for the compression unit is based on how much data will be necessary for the compression unit, e.g. based on the pixel (sampling position) format for the output being generated and the appropriate compression parameters (e.g. block size).

When storage for the compression unit(s) that the tile relates to is or has been allocated, the write-out circuit will write respective pixels (sampling positions) for the tile being written out to the allocated storage of the accumulation buffer 305.

The write out unit 304 determines whether a given pixel being written out is the last pixel for a given compression unit that will be written out from the shader core in question (step 902). The write-out unit then correspondingly marks (flags) the pixel being written out as either being the last pixel for the compression unit in question that will be produced by the shader core (step 903) or not (step 904).

The write-out unit tracks and indicates when a pixel being written out for a tile is the last pixel for a given compression unit that will be generated by the shader core in question (as a given shader core of the graphics processor may only process some but not all of the tiles of the overall render output being generated (with other tiles being processed by other shader cores), such that a given individual shader core may not itself generate all the pixels required for a given compression unit of the overall render output being generated.)

Accordingly, the write-out unit 304 keeps track of when the shader core in question has generated the last pixel that it itself is going to generate for a compression unit for the render output in question, and when it writes out a pixel (sampling position) to the accumulation buffer, indicates that to the accumulation buffer 305 accordingly. The write-out circuit 304 also indicates which compression unit for the output being generated (that the tile being written out belongs to) that each pixel for the tile that is being written out relates to.

This process is repeated until all the pixels for the tile in question have been written out from the tile buffer 303 to the accumulation buffer 305 (step 905).

The next tile (once ready) can then be written out from the tile buffer 303 to the accumulation buffer 305, and so on.

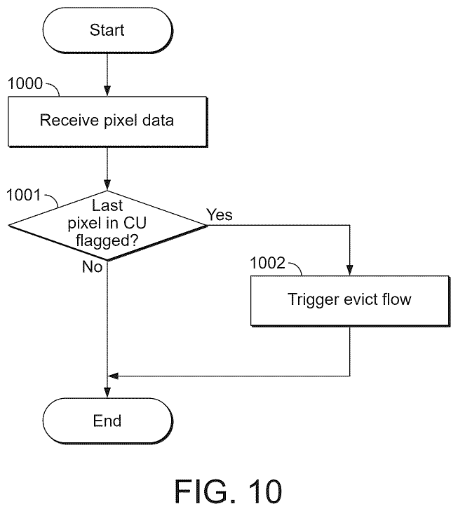

FIG. 10 shows the corresponding operation of the accumulation buffer 305 when receiving pixel data for a tile from the write-out unit 304. As shown in FIG. 10 the accumulation buffer 305 will receive pixel data written by the write-out unit 304 from the tile buffer 303, and add (store) that data to (for) the appropriate stored compression unit that it is accumulating (buffering). The tracking of the data stored for the compression unit will correspondingly be updated (step 1000).

As shown in FIG. 10, the accumulation buffer 305 also checks whether a pixel it receives has been flagged as being the last pixel in a compression unit (for the shader core in question, as discussed above) (step 1001).

When the last pixel for a given compression unit to be generated by a given shader core for a given render output is received by the accumulation buffer, then an appropriate eviction process to output the corresponding encoded compression unit is triggered (step 1002).

Otherwise, the process simply repeats as more pixel data is received.

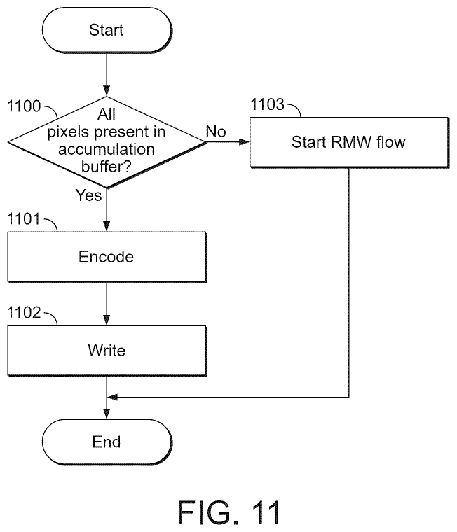

FIG. 11 shows the compression unit “eviction process” that is triggered in step 1002 in FIG. 10 when the last pixel for a compression unit that will be generated by the shader core in question is received by the accumulation buffer 305.

As shown in FIG. 11, the eviction process first determines whether all the pixels for the compression unit in question are present in the accumulation buffer (step 1100). This is determined from the compression unit tracking performed by the accumulation buffer.

If so, then the pixels for the compression unit are sent from the accumulation buffer 305 to the encoder 306, which operates to encode (compress) the compression unit (step 1101) and then write the compressed block of data to the memory system (step 1102).

On the other hand, and as shown in FIG. 11, when it is determined that not all pixels for the compression unit are present in the accumulation buffer (for the shader core in question), a “read-modify-write” flow is performed (step 1103) to enable the encoder 306 to still be provided with a “complete” compression unit for compressing.

In particular, as part of the read-modify-write flow, the accumulation buffer retrieves any “missing” data that it doesn't already store for the compression unit that is to be evicted from the memory system 6, to then be able to provide a complete compression unit to the encoder 306 for processing.

To do this, in the present embodiments, as shown in FIGS. 3 and 4, the accumulation buffer 305 sends an appropriate request to the texture mapper (texture unit) 307, which then operates to retrieve the requested “missing” data from the memory and return it to the accumulation buffer.

Once the accumulation buffer 305 has all the data for the complete compression unit, then it outputs the complete compression unit to the encoder 306 (as discussed above), and the encoder 306 then encodes (compresses) the compression unit and writes it to the memory system accordingly.

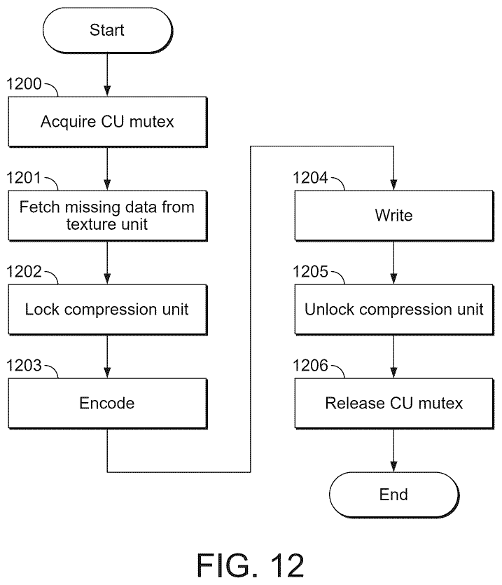

FIG. 12 shows the read-modify-write flow of step 1103 in FIG. 11 in more detail.

As shown in FIG. 12, at the start of this read-modify-write flow, the accumulation buffer 305 first acquires a (global) mutex for the compression unit in question (step 1200) (from the CU mutex handler 405). This is to ensure that only one accumulation buffer at any one time is performing a read-modify-write operation on a given compression unit for a render output. (As, discussed above, different shader cores of the graphics processor may be generating tiles for different parts of the same compression unit. It is therefore desirable to ensure that only one accumulation buffer has access to a compression unit for performing a read-modify-write operation at any one time.)

Once the compression unit mutex has been acquired, the accumulation buffer then signals the texture unit (texture mapper) 307 to fetch the data that it does not have for the compression unit in question (the “missing” compression unit data) from the memory system (step 1201).

The compression unit in question is then “locked”, so as to prevent all other texture mappers in the graphics processor from reading the data of the compression unit that is being encoded. This can be done in any appropriate and desired manner, and is in embodiments achieved by invalidating any and all data related to the compression unit in question in all texture mappers in the GPU (such that they will not use any cached data for the compression unit in question).

In the present embodiments, this is done via the cache coherency protocol of the cache hierarchy for the graphics processor and graphics processing system in question. In embodiments the accumulation buffer sends an appropriate “invalidation” request via the coherency protocol for this purpose.

In an embodiment, where compression units are stored as respective, separate, linked headers and payloads, then a compression unit is “locked” in this way by locking the header (the cache line storing the header) for the compression unit in question, such that that correspondingly causes invalidation of data related to the compression unit in all texture mappers in the graphics processor.

Once the texture unit has acquired the missing data from the memory system and provided it to the accumulation buffer 305, the accumulation buffer then provides the complete compression unit to the encoder 306 which then encodes the compression unit (step 1203) and writes the compression unit to the memory system (step 1204).

Once the compression unit has been written to the memory system, then the compression unit can be “unlocked”, so that texture mappers are able to read the compression unit (from the memory system) (step 1205). Again, this is in embodiments achieved in the appropriate manner for the coherency protocol used in the graphics processor and graphics processing system in question, for example by writing an appropriate (valid) header to the memory system for the compression unit once the payload data for the compression unit has been written to the memory system.

The compression unit mutex is then released (step 1206).

Another accumulation buffer (shader core) can then perform a read-modify-write process for the compression unit, if required.

FIGS. 9-12 show the operation in particular where data for compression units is accumulated in the accumulation buffer before being encoded and written to memory. This operation would be appropriate in the case where any given rendering tile does not provide a complete compression unit for encoding (i.e. where data from more than one rendering tile will be required for a compression unit).

The Applicants have further recognised that there could be situations where data from a single rendering tile provides a complete compression unit for encoding. This could be the case, for example, where the rendering tiles are equal to or larger than the compression units that the block-based encoding uses.

In this case, while it would still be possible simply to accumulate compression unit data in storage of the accumulation buffer and then output the compression units, e.g. “immediately”, in an embodiment, rather than storing the tile data in the accumulation buffer and then providing it from the accumulation buffer storage to the encoder, the tile data is instead streamed directly to the encoder as it is written out from the tile buffer. This may be via a communications path that bypasses the accumulation buffer entirely, or there may, for example, be a communication path that allows tile data to pass through the accumulation buffer without being (temporarily) stored in the storage of the accumulation buffer. In this case, the accumulation buffer will not accumulate any data for the tile, but rather the tile data will be passed directly to the encoder without being accumulated by the accumulation buffer.

Thus, in embodiments of the technology described herein, an accumulation buffer is used to accumulate data from tiles being generated by the graphics processor to provide complete compression units (compression blocks) to the block-based encoding process.

In the eviction process of FIG. 11, when all pixels for a compression unit are present in the accumulation buffer 305 of shader core 400, the pixels for the compression unit are sent from the accumulation buffer 305 to the encoder 306, which encodes (compresses) the compression unit and writes the compressed block of data to the memory system. Otherwise, if not all pixels for a compression unit are present in the accumulation buffer 305 of shader core 400, the read-modify-write flow of FIG. 12 is performed to retrieve any missing data from memory and provide the encoder 306 with all pixels for the compression unit.

As illustrated in FIG. 10, this eviction process may be triggered and performed in response to the accumulation buffer 305 of shader core 400 receiving the last pixel for a given compression unit to be generated by the shader core 400 for a given render output. The same eviction process may also be triggered and performed in the case where existing compression unit data needs to be evicted from the accumulation buffer 305 so as to free up storage for a new compression unit (where there is not enough spare storage capacity in the accumulation buffer storage for that new compression unit).

The Applicants have recognised that the read-modify-write flow of FIG. 12 may be relatively resource intensive, and it may therefore be desirable to reduce the likelihood and frequency of triggering that flow. This may be done by increasing the likelihood that all pixels for a compression unit will be available in accumulation buffer 305 when the eviction process is triggered, and/or by reducing the likelihood of the accumulation buffer 305 running out of storage capacity and thus needing to trigger the read-modify-write flow to free up storage space.

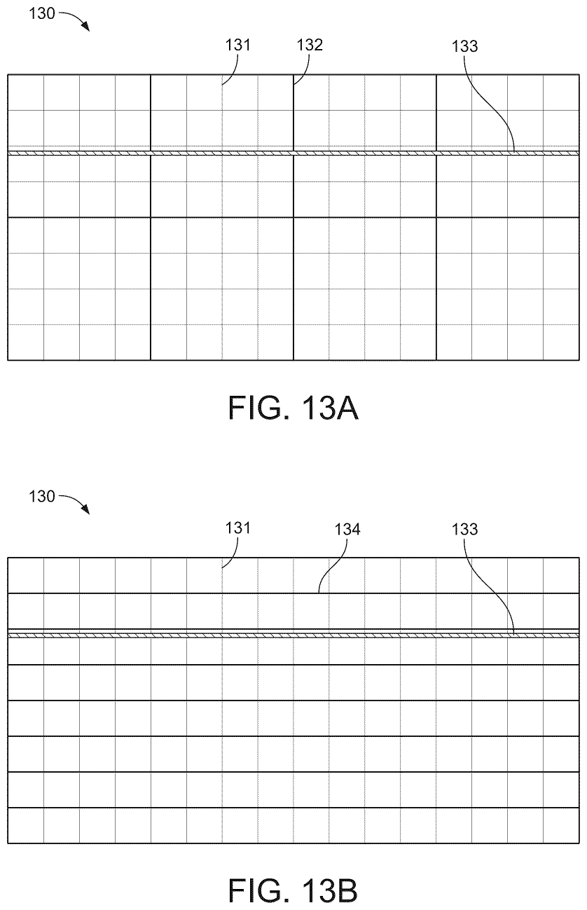

FIG. 13 illustrates one way of reducing the likelihood and frequency of triggering the read-modify-write flow of FIG. 12.

FIG. 13A shows an example frame (image) 130 that is generated as an array of 16×8 tiles 131, with each tile 131 being 16×16 pixels (sampling positions) in size. In this example, frame 130 is stored in memory using relatively “wide” compression units 133 that are each 256×2 pixels (sampling positions) in size (FIG. 13 illustrates only one of these compression units 133 for clarity). Frame 130 is thus organised and stored in memory as a 1×64 array of 256×2 pixel (sampling position) compression units 133.

To facilitate frame 130 being generated in parallel by different shader cores 400, the frame 130 is divided into groups of tiles (“metatiles”) 132, with each group of tiles (“metatile”) 132 being assigned to and generated by a respective shader core 400. In the example of FIG. 13A, each metatile 132 corresponds to a group of 4×4 contiguous tiles and covers a 64×64 pixel (sampling positions) region of the frame 130.

In this example, each metatile 132 is assigned to and generated by a different shader core 400, such that the data for any given compression unit 133 will be generated by four different shader cores. This means that not all pixels for a compression unit 133 will be accumulated in the accumulation buffer 305 of the same shader core 400. This means that the read-modify-write flow will be triggered for an accumulation buffer of a shader core to retrieve data generated by other shader cores.

FIG. 13B shows an improved arrangement. FIG. 13B shows the same frame 130 as FIG. 13A, and is thus generated as an array of 16×8 tiles 131, with each tile 131 being 16×16 pixels (sampling positions) in size. Frame 130 is again stored in memory using relatively “wide” compression units 133 that are each 256×2 pixels (sampling positions) in size. Frame 130 is thus organised and stored in memory as a 1×64 array of 256×2 pixel (sampling position) compression units 133.

To facilitate frame 130 being generated in parallel by different shader cores 400, the frame 130 is again divided into groups of tiles (“metatiles”) 134, with each group of tiles (“metatile”) 134 being assigned to and generated by a respective shader core 400.

In the embodiment of FIG. 13B, in contrast to the embodiment of FIG. 13A, the size and shape of the metatiles 134 is configurable, and is selected based on the size and shape of the compression units 133. In particular, as shown in FIG. 13B, in this embodiment, each metatile 134 corresponds to a group of 16×1 contiguous tiles and covers a relatively “wide” 256×16 Pixel (sampling Positions) region of the frame 130.

Each such “wide” metatile 134 is assigned to and generated by a different shader core 400, such that the data for any given compression unit 133 will be generated by the same shader core 400. This means that all pixels for a compression unit 133 will be accumulated in the accumulation buffer 305 of the same shader core 400. This means that the read-modify-write flow will not need to be triggered for an accumulation buffer of a shader to retrieve data generated by a different shader core.

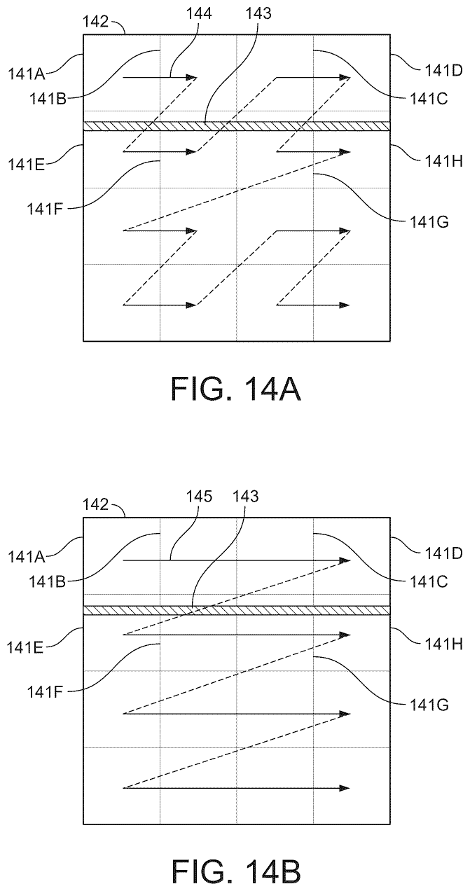

FIG. 14 illustrates another way of reducing the likelihood and frequency of triggering the read-modify-write flow of FIG. 12.

FIG. 14A shows an example 64×64 pixel (sampling positions) metatile 142 of a frame (image) that corresponds to a group of 4×4 contiguous tiles 141, with each tile 141 being 16×16 pixels (sampling positions) in size. In this example, the frame is again stored in memory using relatively “wide” compression units 143, that in this example are each 64×2 pixels (sampling positions) in size (FIG. 14 illustrates only one of these compression units 143 for clarity). All of the 4×4 tiles 141 of metatile 142 are assigned to the same shader core 400 for processing.

FIG. 14A illustrates one way in which the shader core 400 may process and generate the 4×4 tiles 141 of the metatile 142 assigned to it. As illustrated in FIG. 14A, the shader core 400 may process the 4×4 tiles 141 of the metatile 142 in “Z-order” (Morton order) 144. Thus, shader core 400 may generate tile 141A, then tile 141B, then tile 141E, then tile 141F, then tile 141C, then tile 141D, then tile 141G, then tile 141H, etc..

In this example, the first pixels for compression unit 143 will be accumulated by the accumulation buffer 305 of shader core 400 when the shader core 400 generates tile 141E, and then further pixels for compression unit 143 will be accumulated by the accumulation buffer 305 when the shader core 400 generates tile 141F. Shader core 400 will then generate tiles 141C and 141D, and accumulation buffer 305 will accordingly need to accumulate pixel data for compression units corresponding to those tiles. Depending on the storage capacity of accumulation buffer 305, this may trigger eviction of pixel data for compression unit 143 accumulated when generating tiles 141E and 141F. Then, this evicted pixel data may need to be retrieved from memory by accumulation buffer 305 when tiles 141G and 141H are generated in order to obtain all pixels for compression unit 143.

FIG. 14B shows an improved arrangement. FIG. 14B shows the same metatile 142 and compression unit 143 as FIG. 14A. In the embodiment of FIG. 14B, in contrast to the embodiment of FIG. 14A, the order in which the shader core 400 processes the 4×4 tiles 141 of the metatile 142 is configurable, and is selected based on the size and shape of the compression units 143. In particular, as shown in FIG. 14B, in this embodiment, the shader core 400 processes the 4×4 tiles 141 of the metatile 142 in “line-by-line” (raster) order 145. Thus, shader core 400 generates tile 141A, then tile 141B, then tile 141C, then tile 141D, then tile 141E, then tile 141F, then tile 141G, then tile 141H, etc..

In this embodiment, the first pixels for compression unit 143 will again be accumulated by the accumulation buffer 305 of shader core 400 when the shader core 400 generates tile 141E, and then further pixels for compression unit 143 will be accumulated by the accumulation buffer 305 when the shader core 400 generates tile 141F. The remaining pixels for compression unit 143 can then be accumulated by the accumulation buffer 305 when the shader core 400 generates tiles 141G and 141H, and, in contrast with the embodiment of FIG. 14A, there will be no risk of the generation of tiles 141C and 141D triggering eviction of pixel data for compression unit 143.

Thus, selecting the tile processing order based on the compression unit size and shape (e.g. selecting “line-by-line” (raster) order 145 in the case of relatively “wide” compression units 143) can reduce the likelihood of the accumulation buffer 305 becoming full, and thus triggering the read-modify-write flow.

In embodiments, tiles are issued to the graphics processor in the desired processing order (that is based on the compression unit size and shape), and the write out unit (circuit) 304 is forced to write out tiles from the tile buffer 303 in the issue order, e.g. regardless of the order in which the generation of the tiles is actually completed. This can reduce the likelihood of the accumulation buffer 305 becoming full, and thus triggering the read-modify-write flow.

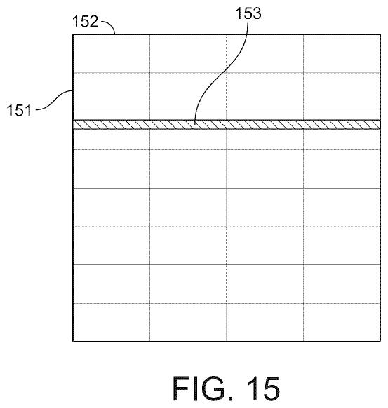

FIG. 15 illustrates a further improved arrangement. FIG. 15 again shows an example 64×64 pixel (sampling positions) metatile 152 of a frame (image). In this embodiment, the frame is again stored in memory using relatively “wide” compression units 153, that in this embodiment are each 64×2 pixels (sampling positions) in size (FIG. 15 illustrates only one of these compression units 153 for clarity).

In this embodiment, the effective tile size is configurable, and is selected based on the size and shape of the compression units 153. In particular, as shown in FIG. 15, in this embodiment, each tile 151 has a smaller, 16×8 pixels (sampling positions) size, and the metatile 152 corresponds to a group of 4×8 contiguous tiles 151.

This can reduce the number of compression units that the accumulation buffer needs to be able to accumulate at the same time (without triggering eviction). For example, assuming a “line-by-line” (raster) order processing order, the embodiment of FIG. 15 will only require that 4 compression units are accumulated at the same time, whereas the embodiment of FIG. 14B will require that 8 compression units are accumulated at the same time. This may be advantageous even though the smaller tile size increases the overall number of tiles that need to be generated.

Thus, reducing the effective tile size based on the compression unit size can reduce the number of compression units for which pixel data needs to be accumulated at the same time. This can reduce the likelihood of the accumulation buffer 305 becoming full, and thus triggering the read-modify-write flow.

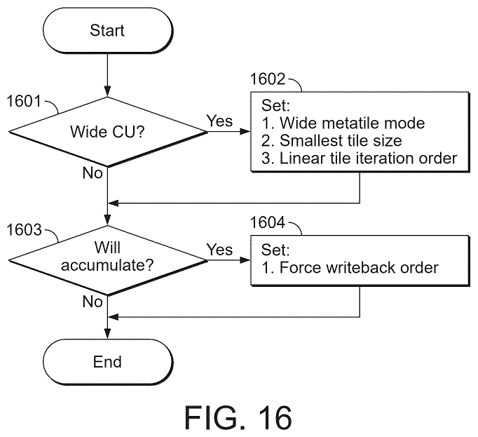

FIG. 16 shows a process for selecting a tile-based rendering configuration, in accordance with embodiments. The process of FIG. 16 may be performed by the driver 10 for the graphics processor, or by the graphics processor 2.

As shown in FIG. 16, when a frame is to be generated, it may be determined whether a particularly wide compression unit is to be used to store the output frame in memory (e.g. wider than a threshold number of pixels) (at step 1601). If it is determined that a wide compression unit size is to be used, then at least one of the metatile size and shape, tile size and shape, and tile processing order may be selected based on the compression unit size and shape (at step 1602), e.g. as described above.

It may then be determined whether the selected configuration will result in all pixel data for a compression unit being generated by the same shader core (at step 1603), and if this is the case, the write out unit (circuit) 304 may be forced to write out tiles from the tile buffer 303 in the order in which the tiles are issued for processing (at step 1604).

The frame may then be generated in accordance with the selected configuration, and encoded.

Even when a tile-based rendering configuration for generating a frame is selected in this manner (based on a compression unit size/shape that is to be used to store the frame in memory), however, it can still be the case that the read-modify-write flow will be triggered.

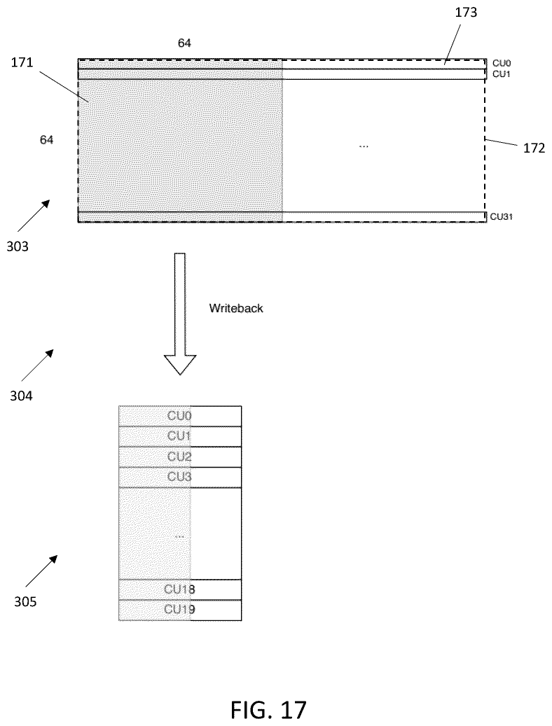

For example, FIG. 17 illustrates a rendering configuration that can cause the accumulation buffer 305 to overflow and trigger the read-modify-write flow.

As illustrated in FIG. 17, in this embodiment, a frame (image) is generated by the graphics processor 2 as an array of tiles 171, with each tile 171 being 64×64 pixels (sampling positions) in size, and with the frame being stored in memory using relatively “wide” compression units 173 that are each 128×2 pixels (sampling positions) in size. In this embodiment, a (each) shader core 400 generates a respective metatile 172 that corresponds to a group of 2×1 contiguous tiles and covers a 128×64 pixel (sampling positions) region of the frame, such that all of the pixel data for any given compression unit 173 will be generated by the same shader core 400. However, each tile 171 overlaps only half of any given compression unit 173, such that each tile 171 only generates half of the pixel data for a compression unit 173.

As discussed above, and as illustrated in FIG. 17, when a shader core 400 has completed generating pixel data for a tile 171, the tile data will be written out by write out unit (circuit) 304 from the tile buffer 303 towards the memory system 6 via the accumulation buffer 305. As described above, this will involve data for compression units 173 that overlap the tile 171 being accumulated in the accumulation buffer 305.

However, in this embodiment, as illustrated in FIG. 17, accumulation buffer 305 can only accumulate data for up to a maximum of 20 compression units at any one time, whereas a tile overlaps 32 compression units. Accumulation buffer 305 therefore does not have enough storage capacity to accumulate data for all of the compression units 173 that overlap the tile 171 at the same time.

This means that when tile 171 is written out, the writing of data to the accumulation buffer 305 for some of the compression units 173 that overlap the tile 171 can trigger eviction from the accumulation buffer 305 of data for other compression units 173 that overlap the (same) tile 171. Moreover, these evictions will be triggered with only half of the pixel data for a compression unit 173 being present in the accumulation buffer 305, resulting in the read-modify-write flow being performed in order to retrieve the “missing” data for the compression unit 173 from the memory system 6.

As discussed above, in the process described e.g. with reference to FIGS. 9 and 10, a compression unit eviction can be triggered in response to the write out unit (circuit) 304 of a shader core 400 indicating to the accumulation buffer 305 that the last pixel for the compression unit for a metatile (group of tiles) that is being generated by the shader core 400 has been written to the accumulation buffer 305, or in response to the accumulation buffer 305 overflowing (being full). The Applicants have realised, however, that this operation can result in an unnecessary delay in triggering the read-modify-write flow. For example, in the rendering configuration illustrated by FIG. 17, the read-modify-write flow may only be triggered due to overflow when data for the 21st compression unit that overlaps tile 171 is written to the accumulation buffer 305, i.e. only after data for the first 20 compression units that overlap tile 171 have been accumulated in the accumulation buffer 305.

In embodiments of the technology described herein, when it is known that a rendering configuration will cause the accumulation buffer 305 to overflow and trigger the read-modify-write flow (such as illustrated by FIG. 17), the write out unit (circuit) 304 and accumulation buffer 305 are caused to operate in an “overflow mode” which attempts to trigger the read-modify-write flow earlier in the write out process (as compared to the “non-overflow” (accumulation) mode of operation described above e.g. with reference to FIGS. 9 and 10).

When operating in overflow mode, compression unit eviction is triggered in response to the write out unit (circuit) 304 indicating to the accumulation buffer 305 that the last pixel for a compression unit for any given tile has been written to the accumulation buffer 305 (e.g. as opposed to the last pixel for a compression unit for a metatile (group of tiles), as in the “non-overflow mode” of FIGS. 9 and 10).

Thus, for example, in the rendering configuration illustrated by FIG. 17, when operating in overflow mode, an eviction will be triggered in response to the last pixel for each compression unit 173 that tile 171 generates pixel data for being written to the accumulation buffer 305. Thus, the read-modify-write flow may be triggered when the last pixel data for the 1st compression unit 173 that overlaps tile 171 is written to the accumulation buffer 305 (e.g. as opposed to waiting for pixel data for the 21st compression unit, as in the “non-overflow mode” of FIGS. 9 and 10).

Thus, operating in overflow mode can reduce or avoid a delay in triggering the read-modify-write flow, and thereby reduce or avoid stalls and speed up the write out process.

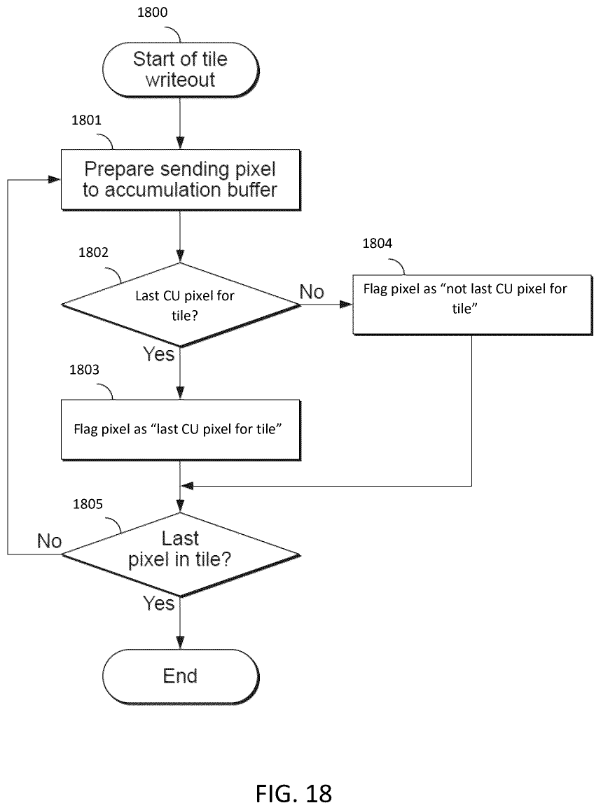

FIG. 18 shows the operation of the write out unit (circuit) 304 when operating in overflow mode. Write-out unit (circuit) 304 may have a bit that is set appropriately to indicate whether overflow mode is enabled or not. The operation of write out unit (circuit) 304 illustrated by FIG. 18 is similar to the “non-overflow” (accumulation) mode illustrated by FIG. 9, and only the main differences will be described.

As illustrated in FIG. 18, when a tile is ready to be written from the tile buffer 303 to the accumulation buffer 305 by the write out unit (circuit) 304 (step 1800), the write out unit (circuit) 304 prepares to write sampling positions (pixels) from the tile buffer 3030 to the accumulation buffer (step 1801).

The write out unit (circuit) 304 determines whether a given pixel being written out is the last pixel for a given compression unit that the tile generates data for (step 1802), and then correspondingly marks (flags) the pixel being written out as either being the last pixel for the compression unit for the tile in question (step 1803) or not (step 1804).

This process is repeated until all the pixels for the tile in question have been written out from the tile buffer 303 to the accumulation buffer 305 (step 1805). The next tile (once ready) can then be written out from the tile buffer 303 to the accumulation buffer 305, and so on.

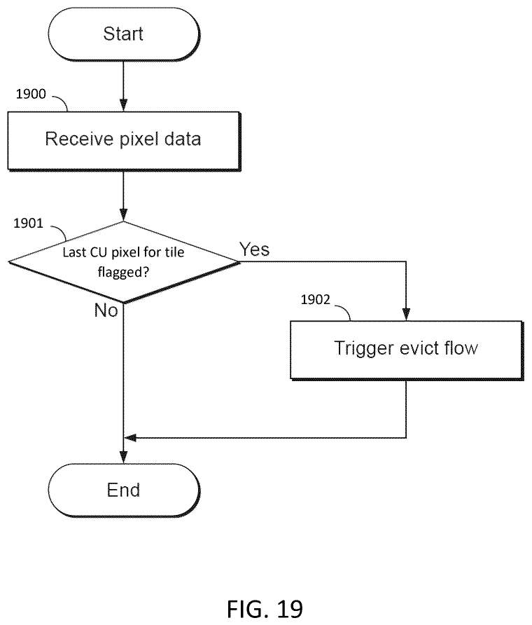

FIG. 19 shows the corresponding operation of the accumulation buffer 305 when operating in overflow mode. The operation of accumulation buffer 305 illustrated by FIG. 19 is similar to the “non-overflow” (accumulation) mode illustrated by FIG. 10, and only the main differences will be described.

As shown in FIG. 19, the accumulation buffer 305 will receive pixel data written by the write out unit (circuit) 304 from the tile buffer 303, and add (store) that data to (for) the appropriate stored compression unit that it is accumulating (buffering) (step 1900).

As shown in FIG. 19, the accumulation buffer 305 checks whether a pixel it receives has been flagged as being the last pixel in a compression unit for a rendering tile (step 1901). When the last pixel for a given compression unit that a given tile generates data for is received by the accumulation buffer 305, then an appropriate eviction process to output the corresponding encoded compression unit is triggered (step 1902). In the present embodiments, the compression unit eviction process shown in FIGS. 11 and 12 and described above is triggered at step 1902.

Overflow mode may be enabled when it is known that a rendering configuration for a frame will cause the accumulation buffer 305 to overflow and trigger read-modify-write. To do this, the driver 10 or graphics processor 2 may, before a new frame is generated, inspect descriptors for the frame to predict whether or not accumulation buffer overflow will occur, and enable overflow mode when it is predicted that accumulation buffer overflow will occur. The Applicants have found, however, that such prediction can be complex and expensive to implement.

In an embodiment, a lookup table is provided that relates rendering configuration parameters (e.g. metatile size/shape, tile size/shape, compression unit size/shape, tile processing order) to accumulation buffer memory footprint, and the driver 10 uses the lookup table to determine whether a rendering configuration for a frame is associated with an accumulation buffer memory footprint that exceeds available accumulation buffer capacity. When it is determined that the available accumulation buffer capacity will be exceeded, overflow mode is enabled (and otherwise “non-overflow” (accumulation) mode is enabled). The use of a lookup table can simplify the determination of whether to enable overflow mode, but can require the storing of a relatively large lookup table.

In embodiments of the technology described herein, the generation of a frame starts with overflow mode not being enabled (i.e. using “non-overflow” (accumulation) mode), and then overflow mode is enabled in response to the accumulation buffer 305 overflowing. The Applicants have found that this can allow overflow mode to be enabled in a particularly simple and efficient manner.

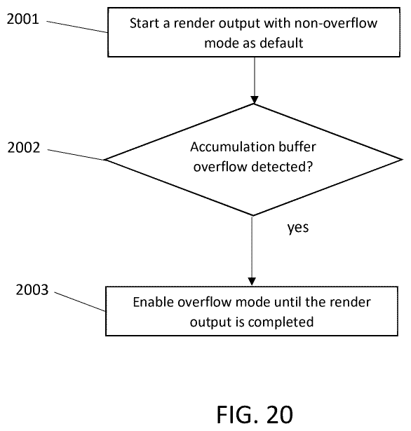

FIG. 20 illustrates a process for generating a frame (render output) in accordance with embodiments of the technology described herein. As shown in FIG. 20, when the graphics processor 2 begins generating a new frame, overflow mode is by default not enabled (step 2001).

A (each) shader core 400 of the graphics processor 2 will thus generate a first rendering tile of the frame, and then when the first tile of the frame is complete, attempt to write out the first tile from the tile buffer 303 towards the memory system 6 via the accumulation buffer 305 using non-overflow (accumulation) mode, e.g. as described above with reference to FIGS. 9 and 10.

In the case of a rendering configuration that does not result in overflow of the accumulation buffer, the first tile will be written out without causing overflow of the accumulation buffer, and thus without triggering overflow mode. As the remaining tiles of the frame will have the same rendering configuration as the first tile, they will also be generated and written out in the same manner, i.e. using non-overflow mode (without overflow mode being enabled).

In the case of a rendering configuration that does result in overflow of the accumulation buffer (such as illustrated in FIG. 17), however, when the write out unit (circuit) 304 attempts to write out the first tile of the frame to the accumulation buffer 305 using non-overflow mode, the accumulation buffer 305 will overflow. As illustrated in FIG. 20, in response to overflow of the accumulation buffer 305 being detected (step 2002), overflow mode is enabled and remains enabled for the remaining tiles of the frame (step 2003). The remaining tiles of the frame will thus be generated and written out with overflow mode enabled.

Overflow mode will then be disabled when the frame is complete and generation of the next frame begins, and so on.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a tile-based graphics processor or a graphics processing system that includes a tile-based graphics processor; wherein the graphics processor is operable to generate a render output and comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
wherein the graphics processor is operable in a first mode of operation in which the accumulation buffer will provide render output data for a compression unit to the encoder for encoding in response to an indication that all render output data for the compression unit that the rendering circuit will generate for a render output has been accumulated by the accumulation buffer;
the method comprising:
causing the graphics processor to operate in a second mode of operation in which the accumulation buffer will provide render output data for a compression unit to the encoder for encoding in response to an indication that all render output data for the compression unit that the rendering circuit will generate for a single rendering tile of a render output has been accumulated by the accumulation buffer.

2. The method of claim 1, comprising:
determining whether a threshold capacity of the accumulation buffer will be exceeded;
when it is determined that the threshold capacity of the accumulation buffer will be exceeded: causing the graphics processor to operate in the second mode of operation; and
when it is not determined that the threshold capacity of the accumulation buffer will be exceeded: causing the graphics processor to operate in the first mode of operation.

3. The method of claim 2, comprising determining whether a threshold capacity of the accumulation buffer will be exceeded using a lookup table.

4. The method of claim 1, comprising:
when beginning generating a render output: causing the graphics processor to operate in the first mode of operation; and
in response to a threshold capacity of the accumulation buffer being exceeded while generating the render output: causing the graphics processor to switch to operating in the second mode of operation until generation of the render output is complete.

5. The method of claim 1, wherein the accumulation buffer providing render output data for a compression unit to the encoder for encoding comprises:
determining whether the accumulation buffer has not accumulated all render output data for the compression unit; and
when it is determined that the accumulation buffer has not accumulated all render output data for the compression unit:
requesting the render output data for the compression unit that the accumulation buffer has not accumulated from a memory system; and
combining render output data returned from the memory system with render output data for the compression unit that the accumulation buffer has accumulated so as to provide a complete version of the compression unit for encoding.

6. The method of claim 1, wherein the graphics processor comprises a tile buffer operable to store a rendering tile of render output data being generated by the rendering circuit.

7. The method of claim 6, wherein the graphics processor comprises a write-out circuit operable to write-out a rendering tile of render output data generated by the rendering circuit from the tile buffer to the accumulation buffer.

8. The method of claim 7, wherein the write-out circuit is operable to:
when operating in the first mode of operation, indicate to the accumulation buffer when all render output data for a compression unit that the rendering circuit will generate for a render output has been written to the accumulation buffer; and
when operating in the second mode of operation, indicate to the accumulation buffer when all render output data for a compression unit that the rendering circuit will generate for a single rendering tile of a render output has been written to the accumulation buffer.

9. A non-transitory computer readable storage medium storing software code which when executing on a processor performs the method of claim 1.

10. A method of operating a tile-based graphics processor or a graphics processing system that includes a tile-based graphics processor; wherein the graphics processor is operable to generate a render output and comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
the method comprising:
when beginning generating a render output: causing the accumulation buffer to provide render output data for a compression unit to the encoder for encoding in accordance with a first mode of operation; and
in response to a threshold capacity of the accumulation buffer being exceeded while generating the render output: causing the accumulation buffer to provide render output data for a compression unit to the encoder for encoding in accordance with a second, different mode of operation until generation of the render output is complete.

11. A tile-based graphics processor or a graphics processing system that includes a tile-based graphics processor; wherein the graphics processor is operable to generate a render output and comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding; and
wherein the graphics processor is operable in a first mode of operation in which the accumulation buffer will provide render output data for a compression unit to the encoder for encoding in response to an indication that all render output data for the compression unit that the rendering circuit will generate for a render output has been accumulated by the accumulation buffer; and
wherein the graphics processor is operable in a second mode of operation in which the accumulation buffer will provide render output data for a compression unit to the encoder for encoding in response to an indication that all render output data for the compression unit that the rendering circuit will generate for a single rendering tile of a render output has been accumulated by the accumulation buffer.

12. The processor or system of claim 11, comprising a processing circuit configured to cause the graphics processor to operate in the first mode of operation or in the second mode of operation.

13. The processor or system of claim 12, wherein the processing circuit is configured to:
determine whether a threshold capacity of the accumulation buffer will be exceeded;
when it is determined that the threshold capacity of the accumulation buffer will be exceeded: cause the graphics processor to operate in the second mode of operation; and
when it is not determined that the threshold capacity of the accumulation buffer will be exceeded: cause the graphics processor to operate in the first mode of operation.

14. The processor or system of claim 13, wherein the processing circuit is configured to determine whether a threshold capacity of the accumulation buffer will be exceeded using a lookup table.

15. The processor or system of claim 12, wherein the processing circuit is configured to:
when beginning generating a render output: cause the graphics processor to operate in the first mode of operation; and
in response to a threshold capacity of the accumulation buffer being exceeded while generating the render output: cause the graphics processor to switch to operating in the second mode of operation until generation of the render output is complete.

16. The processor or system of claim 11, wherein the accumulation buffer is operable to provide render output data for a compression unit to the encoder for encoding by:
determining whether the accumulation buffer has not accumulated all render output data for the compression unit; and
when it is determined that the accumulation buffer has not accumulated all render output data for the compression unit:
requesting the render output data for the compression unit that the accumulation buffer has not accumulated from a memory system; and
combining render output data returned from the memory system with render output data for the compression unit that the accumulation buffer has accumulated so as to provide a complete version of the compression unit for encoding.

17. The processor or system of claim 11, wherein the graphics processor comprises a tile buffer operable to store a rendering tile of render output data being generated by the rendering circuit.

18. The processor or system of claim 17, wherein the graphics processor comprises a write-out circuit operable to write-out a rendering tile of render output data generated by the rendering circuit from the tile buffer to the accumulation buffer.

19. The processor or system of claim 18, wherein the write-out circuit is operable to:
when operating in the first mode of operation, indicate to the accumulation buffer when all render output data for a compression unit that the rendering circuit will generate for a render output has been written to the accumulation buffer; and
when operating in the second mode of operation, indicate to the accumulation buffer when all render output data for a compression unit that the rendering circuit will generate for a single rendering tile of a render output has been written to the accumulation buffer.

20. A tile-based graphics processor or a graphics processing system that includes a tile-based graphics processor; wherein the graphics processor is operable to generate a render output and comprises:
a rendering circuit operable to generate rendering tiles of render output data for a render output;
an encoder operable to encode compression units of render output data; and
an accumulation buffer operable to accumulate render output data generated by the rendering circuit and provide render output data to the encoder for encoding;
wherein the processor or system is operable to:
when beginning generating a render output: cause the accumulation buffer to provide render output data for a compression unit to the encoder for encoding in accordance with a first mode of operation; and
in response to a threshold capacity of the accumulation buffer being exceeded while generating a render output: cause the accumulation buffer to provide render output data for a compression unit to the encoder for encoding in accordance with a second, different mode of operation until generation of the render output is complete.
